(19) United States
(12) Patent Application Publication
(10) Pub. No.: US 2026/0188723 A1
(43) Pub. Date: Jul. 2, 2026

(54) LITHIUM-ION SECONDARY BATTERY

(71) Applicant: ZHUHAI COSMX BATTERY CO., LTD., Zhuhai (CN)

(72) Inventors: Jiao LI, Zhuhai (CN); Jialin FANG, Zhuhai (CN)

(73) Assignee: ZHUHAI COSMX BATTERY CO., LTD., Zhuhai (CN)

(21) Appl. No.: 19/182,877

(22) Filed: Apr. 18, 2025

(30) Foreign Application Priority Data
Dec. 31, 2024 (CN) 202411995767.2

(51) Int. Cl. H01M 10/0525; H01M 4/02; H01M 4/36; H01M 4/38; H01M 4/525; H01M 4/583; H01M 4/62; H01M 10/04; H01M 10/0562; H01M 10/0569

(52) U.S. Cl. CPC H01M 10/0525; H01M 4/364; H01M 4/386; H01M 4/525; H01M 4/583; H01M 4/625; H01M 10/0431; H01M 10/0562; H01M 10/0569; H01M 2004/021; H01M 2004/027; H01M 2004/028; H01M 2300/0051; H01M 2300/0071

(57) ABSTRACT

A lithium-ion secondary battery includes a positive electrode plate and a negative electrode plate, where the negative electrode plate includes a negative electrode current collector and a negative electrode active coating layer located on at least one surface of the negative electrode current collector, the negative electrode active coating layer includes a silicon-carbon material, and a mass content of element Si in the negative electrode active coating layer c1 ranges from 1.5% to 8.5%; the positive electrode plate includes lithium cobaltate; and an inflection point of a ZCV curve of the lithium-ion secondary battery corresponds to a value Z on an X axis, and Z ranges from 55% to 90%. The lithium-ion secondary battery of the present disclosure has a relatively high energy density and a relatively good low-temperature discharge performance.

### CROSS-REFERENCE TO RELATED APPLICATIONS

This application claims priority to Chinese Patent Application No. 202411995767.2, filed on Dec. 31, 2024, which is hereby incorporated by reference in its entirety.

### TECHNICAL FIELD

The present disclosure relates to the technical field of batteries, in particular to a lithium-ion secondary battery.

### BACKGROUND

As the doping amount of silicon increases, the capacity of a battery can significantly increases when it is discharged to 3.0 V, thus achieving the purpose of increasing the energy density of the battery. However, during actual use, after the battery is assembled into a powered device, since the opening voltage of the powered device is generally 3.4 V and the discharge capacity at 3.4 V/discharge capacity at 3.0 V of the silicon-doped system is significantly lower than that of a pure graphite system, the silicon-doped battery has the problem of a relatively low platform voltage. This leads to a relatively low discharge capacity of the silicon-doped battery during practical use, especially in a low-temperature environment (for example, at an air temperature of −20° C. or lower), and it is even more difficult to keep the battery operating at 3.4 V or higher.

Therefore, it is very important to address the problem that silicon-doped batteries with a high energy density cannot discharge in a low-temperature environment.

### SUMMARY

An object of the present disclosure is to provide a lithium-ion secondary battery in order to overcome the problem in the prior art that a silicon-doped battery with a high energy density cannot discharge in a low-temperature environment. As for the lithium-ion secondary battery (hereinafter referred to as battery) of the present disclosure, by regulating both the mass content of the element Si in the negative electrode active coating layer and the position of the inflection point in the Zero Current Voltage (ZCV) curve of the battery, the problem that a silicon-doped battery with a high energy density cannot discharge in a low-temperature environment can be effectively improved.

The present disclosure provides a lithium-ion secondary battery including a negative electrode plate, wherein the negative electrode plate includes a negative electrode current collector and a negative electrode active coating layer located on at least one surface of the negative electrode current collector, the negative electrode active coating layer includes a silicon-carbon material, and a mass content of element Si in the negative electrode active coating layer c1 ranges from 1.5% to 8.5%; the positive electrode plate includes a positive electrode active material, and the positive electrode active material includes lithium cobaltate; and an inflection point of a ZCV curve of the lithium-ion secondary battery corresponds to a value Z on an X axis (SOC), and Z ranges from 55% to 90%.

The ZCV curve of the battery can not only directly characterize the internal resistance change of the battery, but can also explain the structural abrupt change of the positive and negative electrodes. In a silicon-doped system, the inflection point represents that the silicon in the negative electrode active material begins to undergo lithium intercalation at this SOC. In general, the inflection point gradually decreases with the increase of the doping amount of silicon, that is, at a relatively low capacity, silicon begins to undergo lithium intercalation, which leads to the decrease of the operating platform voltage of the battery. Therefore, the position of the inflection point of the ZCV curve directly affects the level of the operating platform voltage of the battery. The closer to 0% SOC the position of the inflection point, the lower the operating platform voltage of the battery. In contrast, the closer to 100% SOC the position of the inflection point, the higher the operating platform voltage of the battery. By adjusting the position of the inflection point of the ZCV curve, the operating platform voltage of the battery can be optimized, so as to improve the capacity when discharge to 3.4 V and address the problem that the battery cannot discharge in a low-temperature environment. However, it does not mean that the closer to 100% SOC the position of the inflection point of the ZCV curve, the better, because the position of the inflection point closer to 100% SOC indicates that the overall energy density of the battery is relatively low, which does not meet the market demand. Therefore, it is necessary to adjust the appropriate Z value. When Z is 55-90%, the battery can achieve a balance between a high energy density and an excellent low-temperature discharge performance and has more market application prospects.

By means of the above technical solution, the present disclosure has at least the following advantages over the prior art.

Firstly, the present disclosure can effectively address the problem that silicon-doped batteries with a high energy density cannot discharge in a low-temperature environment.

Secondly, the battery of the present disclosure can achieve a balance between a high energy density and an excellent low-temperature discharge performance.

The endpoints of ranges and any values disclosed herein are not limited to such exact ranges or values, and these ranges or values should be understood to include values close to these ranges or values. For numerical value ranges, one or more new numerical value ranges can be obtained between endpoint values of various ranges, between endpoint values of various ranges and individual point values, and between individual point values, and these numerical value ranges should be regarded as specifically disclosed herein.

### BRIEF DESCRIPTION OF THE DRAWINGS

FIG. 1 shows a ZCV curve of a lithium-ion secondary battery in an example of the present disclosure.

FIG. 2 shows a ZCV curve of a lithium-ion secondary battery of the present disclosure.

FIG. 3 is a schematic view showing the structure of a jelly roll in an example of the present disclosure.

FIG. 4a is a schematic view (top view) showing grooves on a surface of a negative electrode plate in an example of the present disclosure.

FIG. 4b is a schematic view (top view) showing grooves on a surface of a negative electrode plate in an example of the present disclosure.

FIG. 5a is a schematic view showing the width of grooves in an example of the present disclosure.

FIG. 5b is a schematic view showing the width of grooves in an example of the present disclosure.

FIG. 5c is a schematic view showing the width of grooves in an example of the present disclosure.

FIG. 5d is a schematic view showing the width of grooves in an example of the present disclosure.

FIG. 6a is a schematic view showing the spacing of grooves in an example of the present disclosure.

FIG. 6b is a schematic view showing the spacing of grooves in an example of the present disclosure.

FIG. 6c is a schematic view showing the spacing of grooves in an example of the present disclosure.

FIG. 7 is a schematic view showing the structure of a jelly roll in an example of the present disclosure.

FIG. 8a is a schematic view showing the structure of a positive electrode plate in an example of the present disclosure.

FIG. 8b is a schematic view showing the structure of a positive electrode plate in an example of the present disclosure.

FIG. 9 is a schematic top view showing a first surface of a positive electrode plate in an example of the present disclosure.

### DETAILED DESCRIPTIONS OF THE EMBODIMENTS

Hereinafter, specific embodiments of the present disclosure will be described in detail. It should be understood that the specific embodiments described herein are only used to illustrate and explain the present disclosure and are not used to limit the present disclosure.

The present disclosure provides a lithium-ion secondary battery. The lithium-ion secondary battery includes a negative electrode plate. The negative electrode plate includes a negative electrode current collector and the negative electrode active coating layer located on at least one surface of the negative electrode current collector. The negative electrode active coating layer includes a silicon-carbon material. A mass content of element Si in the negative electrode active coating layer c1 ranges from 1.5% to 8.5%, e.g., 1.5%, 2%, 2.5%, 3%, 3.5%, 4%, 4.5%, 5%, 5.5%, 6%, 6.5%, 7%, 7.5%, 8%, or 8.5%.

In one example, the mass content of the element Si in the negative electrode active coating layer c1 ranges from 3.5% to 6.5%.

In the present disclosure, the mass content of the element Si in the negative electrode active coating layer c1 can be determined by testing with a conventional method in the art. For example, after a battery is discharged to 0% SOC, a negative electrode plate is disassembled, taken out and soaked in the solvent dimethyl carbonate (DMC) for 12 h; the negative electrode plate is then rinsed with the solvent DMC to remove a lithium salt adhered thereto and dried in the air, and the negative electrode plate is then treated at a high temperature of 400° C. in an inert atmosphere for 2 h (for example, in a tube furnace in a nitrogen or argon atmosphere); and the negative electrode active coating layer can thus be gently scraped off the negative electrode current collector, and the negative electrode active coating layer is collected as a test sample. Using a thermogravimetric analyzer (e.g., TGA 550 thermogravimetric analyzer), an amount of 5-15 mg of the test sample is heated from room temperature (25° C.) to 900° C. at a ramp rate of 10° C./min in an air or oxygen atmosphere and maintained at 900° C. for 40 min, so that silicon can be fully oxidized into silicon dioxide while the non-silicon components in the negative electrode active coating layer can be volatilized. The residual substance is namely the ash of the negative electrode active coating layer. The mass content of the element Si in the negative electrode active coating layer can be calculated based on the mass of the ash, and the calculation formula is as follows: the mass content of the element Si in the negative electrode active coating layer=7×the mass of the ash/(15×the mass of the test sample).

In the present disclosure, the lithium-ion secondary battery further includes a positive electrode plate. The positive electrode plate can include a positive electrode active material. The positive electrode active material includes lithium cobaltate.

In the present disclosure, an inflection point of a ZCV curve of the lithium-ion secondary battery corresponds to a value Z on an X axis (SOC), and Z ranges from 55% to 90%, e.g., 55%, 60%, 65%, 70%, 75%, 80%, 85%, or 90%.

In one example, Z ranges from 60% to 75%.

In the present disclosure, a method for testing the ZCV curve of the lithium-ion secondary battery is as follows.
S1, the lithium-ion secondary battery is discharged to 3.0 V at 0.1 C, charged to 4.5 V at 0.2 C, maintained at a constant voltage to 0.05 C and left to stand for 2 h;
S2, the lithium-ion secondary battery is discharged at 0.1 C for 6 min;
S3, the lithium-ion secondary battery is left to stand for 35 min; and
S4, steps S2 and S3 are repeated until the voltage of the lithium-ion secondary battery is ≤2.8 V.

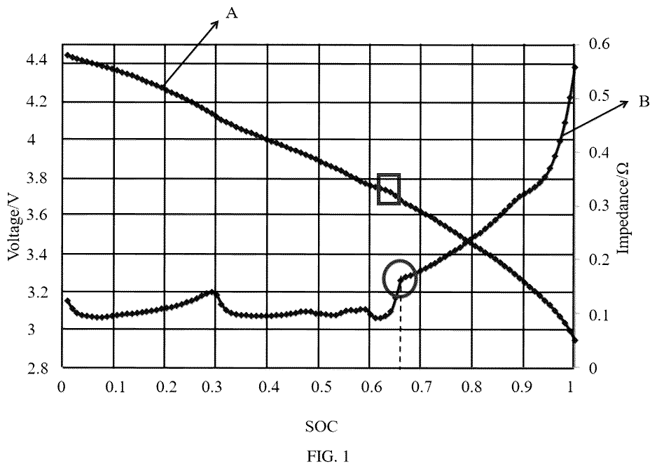

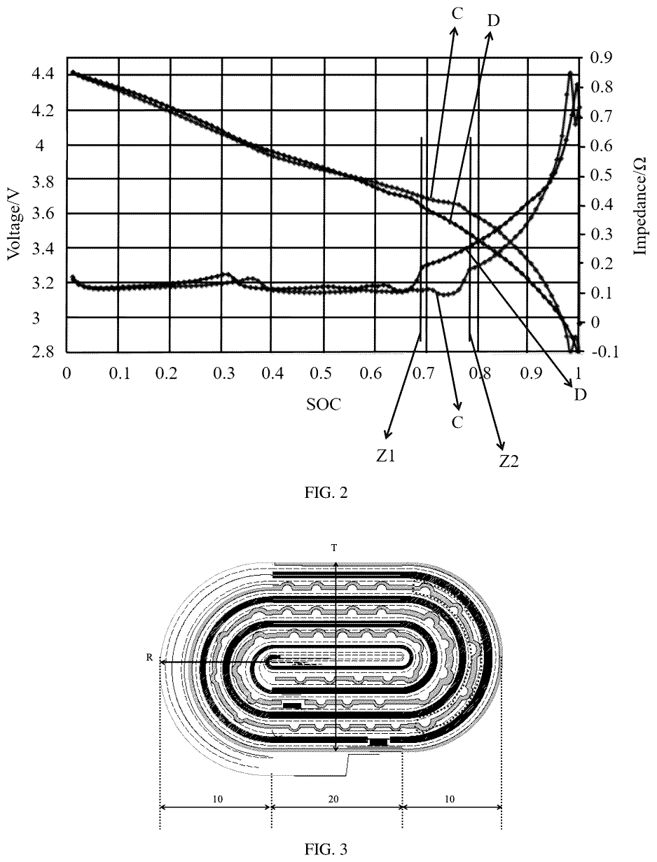

Plotting of ZCV curve (i.e., dynamic impedance calculation): in the adjacent steps S2 and S3, a curve of SOC versus dynamic impedance is plotted with the capacity difference after discharging at 0.1 C for 6 min/the total discharge capacity as the X axis and the dynamic impedance as the Y axis, wherein dynamic impedance=the voltage difference after discharging at 0.1 C for 6 min in the adjacent steps S2 and S3/the capacity at 0.1 C. Thus, the ZCV curve can be obtained. FIG. 1 shows a ZCV curve of a lithium-ion secondary battery in an example of the present disclosure. As can be seen from the figure, the ZCV curve has two curves, wherein curve A is a discharge curve and curve B is an impedance curve. In the impedance curve, a point circled by a circle is the inflection point, and Z is 60-75%. The platform voltage of the battery can be calculated by this discharge curve, and in the discharge curve, the position of the point corresponding to the inflection point (outlined by a square in the figure) directly affects the platform voltage of the battery. The closer to 0% SOC the point, the lower the SOC corresponding to the 3.4 V voltage, that is, the lower the 3.4 V capacity/the 3.0 V capacity, the lower the platform voltage of the battery; on the contrary, the closer to 100% SOC, the higher the platform voltage of the battery. The inflection point of the ZCV curve refers to the abrupt change point of the dynamic impedance of the battery. The slope of the dynamic impedance curve suddenly increases at first and then suddenly decreases near this inflection point. This process is accompanied by the significant increase of the impedance. The junction point between the two is the inflection point, and at the same time, the slope of the discharge curve changes significantly. The confirmation of the position of the inflection point in the ZCV curve is conventional in the art. FIG. 2 shows a ZCV curve of a lithium-ion secondary battery of the present disclosure, in which curves D are a group of batteries, and Z1 marks the inflection points of the curves D; curves C are another group of batteries, and Z2 marks the inflection points of the curves C.

In the present disclosure, the negative electrode active coating layer includes a negative electrode active material. The negative electrode active material includes a silicon-carbon material. The silicon-carbon material can include a primary spherical particle. An average particle size of the primary spherical particle can range from 1 μm to 6 μm, e.g., 1 μm, 2 μm, 3 μm, 4 μm, 5 μm, or 6 μm.

In one example, the average particle size of the primary spherical particle ranges from 3 μm to 5 μm.

Conventionally used silicon-carbon materials are blocky, and the average particle size is about 6-12 μm. A relatively large average particle size leads to a relatively poor conductivity of the particles. In addition, since the hardness of the silicon-carbon material is relatively large, the compaction density thereof is relatively small, resulting in limited improvement in the energy density of the battery. Using the silicon-carbon material of primary spherical particles with an average particle size of 1-6 μm can not only effectively increase the content of silicon in the negative electrode active coating layer, that is, the content of silicon in the negative electrode active coating layer is up to 1.5-8.5%, but can also significantly improve the energy density of the battery; moreover, the particle size thereof is smaller, the conductivity is better, and the overall operating platform voltage of the battery can be further improved, thus addressing the problem of a relatively low operating platform voltage of a silicon-doped battery system.

In the present disclosure, the average particle size of the primary spherical particle can be determined by testing with a conventional method in the art. For example, after a battery is discharged to 0% SOC, a negative electrode plate is disassembled, taken out and soaked in the solvent DMC for 12 h; the negative electrode plate is then rinsed with the solvent DMC to remove a lithium salt adhered thereto and cut by argon ion grinder CP laser and then observed by SEM (using a high-voltage mode (Back-scattered Electrons BSE)), wherein in this mode, the contrast of the silicon-carbon material is bright (which can be used to distinguish the graphite material and the conductive agent in the negative electrode active coating layer); and after measurement at a magnification of 5K, at least 20 primary spherical particles are randomly selected to measure the particle size of each primary spherical particle, and the average value is taken. If the number of primary spherical particle is less than 20 at the magnification of 5K, another microscope image is taken until the 20 primary spherical particles are measured.

In the present disclosure, the silicon-carbon material can further include a secondary spherical particle formed from a plurality of the primary spherical particles. The term “plurality of” means that the number of the primary spherical particle forming the secondary spherical particle is greater than or equal to 2.

As described above, conventionally used silicon-carbon materials have poor conductivity and limited improvement in energy density. In the present disclosure, a silicon-carbon material including a primary spherical particle is used as the negative electrode active material. The primary spherical particle with a relatively small particle size is beneficial to improve the energy density of the battery; However, due to the relatively small particle size thereof, the specific surface area is relatively large, so that the risk of side reactions with the electrolyte solution is correspondingly increased, leading to a poor stability. In order to reduce the side reactions between the silicon-carbon material and the electrolyte solution, a secondary spherical particle formed from a plurality of the primary spherical particles is further added. The secondary spherical particle with a relatively large particle size has a relatively small specific surface area, so the risk of side reactions with the electrolyte solution is relatively low, leading to a relatively good stability. The silicon-carbon material is a combination of the primary spherical particle and the secondary spherical particle, which can improve the cycling stability of the battery while ensuring a relatively high energy density and excellent low-temperature discharge performance.

In the present disclosure, a mass content of the element Si in the silicon-carbon material can range from 30% to 80%, e.g., 30%, 35%, 40%, 45%, 50%, 55%, 60%, 65%, 70%, 75%, or 80%.

In the present disclosure, a proportion of a number of the primary spherical particle in the negative electrode active coating layer relative to a total number of the primary spherical particle and the secondary spherical particle ranges from 0.1 to 0.9, e.g., 0.1, 0.2, 0.3, 0.4, 0.5, 0.6, 0.7, 0.8, or 0.9.

In one example, the proportion of the number of the primary spherical particle in the negative electrode active coating layer relative to the total number of the primary spherical particle and the secondary spherical particle ranges from 0.3-0.8.

As described previously, primary spherical particle with a relatively small particle size is beneficial to improve the energy density and low-temperature discharge performance of the battery, but the stability is relatively poor; in contrast, secondary spherical particle with a relatively large particle size has better stability, but has difficulty in achieving a large compaction density, and the conductivity is relatively poor. After the primary spherical particle and the secondary spherical particle are mixed in a specific quantitative ratio, the arrangement of the silicon-carbon material can be more compact, which is not only conducive to improving the conductivity of the silicon-carbon material itself, but can also improve the compaction of the negative electrode plate, thus further improving the energy density and low-temperature discharge performance of the battery. Moreover, when the primary spherical particle and the secondary spherical particle are mixed in a specific quantitative ratio, the risk of side reactions between the silicon-carbon material and the electrolyte solution can be reduced, which is beneficial to improving the cycling stability of the battery.

In the present disclosure, the number of the primary spherical particle and the number of the secondary spherical particle in the negative electrode active coating layer can be determined by testing with a conventional method in the art. For example, after a battery is discharged to 0% SOC, a negative electrode plate is disassembled, taken out and soaked in the solvent DMC for 12 h; the negative electrode plate is then rinsed with the solvent DMC to remove a lithium salt adhered thereto and cut along the thickness direction of the negative electrode plate by argon ion grinder CP laser and then observed by SEM (using a high-voltage mode) to obtain a microscope image of the cross section of the negative electrode plate along the thickness direction; after observation at a magnification of 1K, at least 20 microscope images of different cross sections are selected, the number of the primary spherical particle and the number of the secondary spherical particle in each microscope image are counted separately, and the average value is taken.

In the present disclosure, the negative electrode active material can further include a graphite material. The graphite material includes, for example, artificial graphite and/or natural graphite. The graphite material includes a secondary particle. The secondary particle is formed from a plurality of primary particles. The term “plurality of” means that the number of the primary particles forming the secondary particle is greater than or equal to 2.

In the present disclosure, an average particle size of the secondary particle can range from 6 μm to 20 μm, e.g., 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm.

The conductivity and stability of a graphite material is superior to that of a silicon-carbon material. Therefore, by using a specific graphite material in combination and adjusting the structure and particle size of the graphite material, the graphite material includes secondary particle formed from primary particles, and the average particle size of the secondary particle is 6-20 μm, so that the cycling stability and low-temperature discharge performance of the battery can be further improved while ensuring that the battery has a relatively high energy density. Compared with a graphite material of primary particles, secondary particle of the graphite material with a specific particle size can improve the energy density of the battery. Therefore, the graphite material has a relatively high matching degree with the specific silicon-carbon material, which is conducive to not only the improvement of the cycling stability and low-temperature discharge performance, but also conducive to the improvement of the energy density.

In the present disclosure, the average particle size of the secondary particle can be determined by testing with a conventional method in the art. For example, after a battery is discharged to 0% SOC, a negative electrode plate is disassembled, taken out and soaked in the solvent DMC for 12 h; the negative electrode plate is then rinsed with DMC to remove a lithium salt adhered thereto, and the negative electrode active coating layer is then washed off a negative electrode current collector with deionized water, and after an ultrasonic treatment and centrifugation to remove the filtrate, the remaining material is dried in the air; and the obtained sample is dispersed in deionized water containing nonylphenol polyoxyethylene ether (in which the mass content of nonylphenol polyoxyethylene ether is 0.02-0.03%) to form a mixture, and after an ultrasonic treatment for 2 minutes, the sample is tested by Malvern particle size tester to obtain median particle size Dv50 data, namely the average particle size of secondary particle. Due to the specific composition and particle size of the graphite material and silicon-carbon material in the present disclosure, the silicon-carbon material has little influence on the average particle size of the secondary particle of the graphite material, and therefore, the data obtained by using the above test method is namely the average particle size of the secondary particle.

In the present disclosure, the positive electrode plate includes a positive electrode active coating layer comprising the positive electrode active material, and the lithium cobaltate contains element Al; in addition, a charged cut-off voltage of the lithium-ion secondary battery is greater than or equal to 4.5 V. The term charged cut-off voltage has the conventional meaning in the art and generally refers to the maximum voltage that a battery can safely reach during charging.

With the increase of the upper limit of the charging voltage of the battery, especially when the charged cut-off voltage of the battery is greater than or equal to 4.5 V, the potential on the positive electrode side also becomes higher and higher, and thus, the challenge to the stability of the lattice structure of lithium cobaltate becomes greater. On the one hand, the element Al is capable of forming an Al—O bond, which has a relatively large bond energy, with the element O in lithium cobaltate, thus effectively suppressing the lattice oxygen from escaping; on the other hand, Al³⁺ is more stable in the octahedral structure of lithium cobaltate, which makes it more difficult for lithium cobaltate to transform into a monoclinic system, thus reducing the kinetics of the formation of the monoclinic system and inhibiting the phase transition of lithium cobaltate. Therefore, when lithium cobaltate contains the element Al, it can stabilize the lattice structure, which is beneficial to further improve the cycling stability of the battery.

In the present disclosure, a mass content of the element Al in the positive electrode active coating layer can range from 6800 ppm to 15000 ppm, e.g., 7000 ppm, 8000 ppm, 9000 ppm, 10000 ppm, 11000 ppm, 12000 ppm, 13000 ppm, 14000 ppm, or 15000 ppm.

In one example, the mass content of the element Al in the positive electrode active coating layer ranges from 7000 ppm to 10000 ppm.

As described previously, the element Al can stabilize the lattice structure of lithium cobaltate. However, it does not mean that the greater the content of the element Al, the better. This is because when the content of the element Al increases, the gram capacity of lithium cobaltate decreases, which will affect the overall energy density of the battery. Therefore, it is necessary to adjust the mass content of the element Al in the positive electrode active coating layer, such that when a specific range is met, stable operation of the positive electrode plate under a high voltage (e.g., 4.5 V or higher) can be ensured, and sufficient capacity utilization of the positive electrode plate is ensured, while loss in energy density caused by an excessively high mass content of the element Al is avoided.

In the present disclosure, the mass content of the element Al in the positive electrode active coating layer can be determined by testing with a conventional method in the art, e.g., by using an inductively coupled plasma-optical emission spectrometer (ICP-OES), and the specific test method is as follows: after a battery is discharged to 0% SOC, a positive electrode plate is disassembled, taken out and soaked in the solvent DMC for 12 h; and the positive electrode plate is then rinsed with the solvent DMC to remove a lithium salt adhered thereto and calcined in a muffle furnace at 400° C. for 3 h, the positive electrode active coating layer is then gently scraped off the surface of the positive electrode current collector, and the mass content (in ppm, i.e., parts per million) of the element Al is measured by ICP-OES. The specific operation method is carried out according to GB/T 30902-2014.

In the present disclosure, a chemical formula of lithium cobaltate can be LiₐCO_{b}M_{c}O₂, in which 0.8≤a≤1.05, 0.85≤b<1, 0<c≤0.15, and M includes at least one of Al, Mg, Ti, Y, La, Ga, Ge, Sn, Si, Zr, Ca, Sb, In, Ni, or Mn. The lithium cobaltate can include first particles and second particles, wherein an average particle size of the first particles can range from 0.3 μm to 7 μm (e.g., 0.3 μm, 0.5 μm, 1 μm, 2 μm, 3 μm, 4 μm, 5 μm, 6 μm, or 7 μm), and the average particle size of the second particles can range from 7.5 μm to 40 μm (e.g., 7.5 μm, 10 μm, 15 μm, 20 μm, 25 μm, 30 μm, 35 μm, or 40 μm). In the case of using the lithium cobaltate of the first particles and second particles with different average particle sizes, the difference of particle size distribution therebetween can directly affect the filling effect of lithium cobaltate powder in the process of compression, which in turn affects the compaction density and electron conductivity of the lithium cobaltate, thus facilitating the improvement of the overall energy density and fast charging capability of the battery.

In the present disclosure, the average particle size of the first particles and the average particle size of the second particles can be determined by testing with a conventional method in the art. For example, after a battery is discharged to 0% SOC, a positive electrode plate is disassembled, taken out and soaked in the solvent DMC for 12 h; the positive electrode plate is then rinsed with the solvent DMC to remove a lithium salt adhered thereto and calcined in a muffle furnace at 400° C. for 3 h; and the positive electrode active coating layer is gently scraped off the surface of the positive electrode current collector and tested using a laser particle analyzer, and the particle size ranges of the first particles and the second particles can be derived from the resulting curves.

In the present disclosure, the lithium-ion secondary battery can further include a first solid electrolyte and/or a second solid electrolyte, wherein the first solid electrolyte and the second solid electrolyte can each independently include at least one of lithium aluminum titanium phosphorus oxide, lithium lanthanum zirconium tantalum oxide, and lithium lanthanum titanium oxide. The lithium aluminum titanium phosphorus oxide can be superionic conductor-type lithium aluminum titanium phosphorus oxide having a molecular formula of Li₁₊ₓAlₓTi₂₋ₓ(PO₄)₃, with 0<x≤0.5. The lithium lanthanum zirconium tantalum oxide can be garnet-type lithium lanthanum zirconium tantalum oxide having a molecular formula of Li_{7-y}La₃Zr_{2-y}Ta_{y}O₁₂, with 0≤y≤0.5. The lithium lanthanum titanium oxide can be perovskite-type lithium lanthanum titanium oxide having a molecular formula of Li_{3z}La_{2/3-z}TiO₃, with 0<z≤0.2. A solid electrolyte satisfying the above molecular formula has a relatively strong ionic conductivity, a relatively high dielectric coefficient, and a good affinity for the electrolyte solution; When used for a battery, it can improve the overall ion transport capacity of the battery and improve the kinetic performance of the battery, further enabling the battery to have a high energy density and also a good low-temperature discharge performance.

In one example, the negative electrode active coating layer further includes the first solid electrolyte.

The conductivity of the silicon-carbon material itself is relatively poor, and with the decrease of the temperature, the ionic conductivity of the electrolyte solution decreases significantly, and the silicon-doped battery system is faced with the problem of discharge failure in extreme weathers at low temperatures (for example, the air temperature is −20° C. or lower). The ionic conductivity of the solid electrolyte decreases insignificantly with the decrease of the temperature. The addition of the solid electrolyte to the negative electrode active coating layer allows ions to be conducted along the solid electrolyte at extremely low temperature conditions, thus replacing the conduction path of part of the electrolyte solution and further ensuring that the battery can discharge normally under low-temperature conditions.

In the present disclosure, the first solid electrolyte includes element M¹, and the element M¹ includes at least one of Ti, Zr, La, or Ta. A mass content of the element M¹ in the negative electrode active coating layer c2 and the mass content of the element Si in the negative electrode active coating layer c1 satisfy: 0.01≤c2/c1≤0.5, e.g., 0.01, 0.02, 0.03, 0.04, 0.05, 0.06, 0.07, 0.08, 0.09, 0.1, 0.2, 0.3, 0.4, or 0.5.

In one example, 0.05≤c2/c1≤0.1.

Since the first solid electrolyte has excellent ionic conductivity in a low-temperature environment, the platform voltage of the battery at a low temperature can be significantly increased, thereby improving the discharge capacity at the low temperature. In a certain range, with the increase of the mass content of the element Si in the negative electrode active coating layer, the platform voltage of the battery in the whole temperature range decreases to some extent, and especially in a low-temperature environment, the decrease is more significant. Therefore, when the content of the first solid electrolyte in the negative electrode plate is relatively high, the mass content of the element Si in the negative electrode plate can be appropriately increased, and in this case, the operating platform voltage of the battery can be maintained at a relatively high level. Moreover, when the content of the first solid electrolyte in the negative electrode plate is relatively low, it is necessary to appropriately reduce the mass content of the element Si in the negative electrode plate to maintain a relatively high operating platform voltage. Incorporating the first solid electrolyte in the negative electrode plate can recover the loss of discharge capacity in a low-temperature environment caused by a high doping amount of silicon and achieve the purpose of achieving a balance between a high energy density at room temperature and a high discharge capacity at a low temperature.

In the present disclosure, the mass content of the element M¹ in the negative electrode active coating layer c2 can range from 0.1% to 0.5%, e.g., 0.1%, 0.2%, 0.3%, 0.4%, or 0.5%. The mass content of the element M¹ in the negative electrode active coating layer c2 can be determined by testing with a conventional method in the art. For example, after a battery is discharged to 0% SOC, a negative electrode plate is disassembled, taken out and soaked in the solvent DMC for 12 h; the negative electrode plate is then rinsed with the solvent DMC to remove a lithium salt adhered thereto and cut along the thickness direction of the negative electrode plate by argon ion grinder CP laser and then subjected to elemental analysis at a magnification of 1K by means of SEM combined with an energy dispersive spectrometer (EDS), so that the mass content is obtained. “The mass content of the element M¹ in the negative electrode active coating layer c2” refers to the mass content of at least one element M¹ in the first solid electrolyte in the negative electrode active coating layer. For example, when the first solid electrolyte is lithium lanthanum zirconium tantalum oxide, the lithium lanthanum zirconium tantalum oxide includes three elements M¹: La, Zr, and Ta, and thus, c2 means that the mass content of at least one of the element La, the element Zr, or the element Ta in the negative electrode active coating layer c2 satisfies the above relationship.

In one example, the positive electrode active coating layer further includes a second solid electrolyte.

As described previously, the ionic conductivity of the second solid electrolyte decreases insignificantly with the decrease of the temperature. The addition of the second solid electrolyte to the positive electrode plate allows ions to be conducted along the solid electrolyte at extremely low temperature conditions, thus replacing the conduction path of part of the electrolyte solution and ensuring that the battery can discharge normally under low-temperature conditions. In addition, since the discharge process is a process of lithium deintercalation at the negative electrode and lithium intercalation at the positive electrode, it is necessary to preferentially increase the lithium intercalation rate at the positive electrode side in order to improve the low-temperature discharge performance of the battery.

In the present disclosure, the second solid electrolyte includes element M², and the element M² includes at least one of Ti, Zr, La, or Ta. A mass content of the element M² in the positive electrode active coating layer c3 and the value Z of the inflection point corresponding to the X axis satisfy: 3.3×10⁻⁴≤c3×Z≤1.4×10⁻³, e.g., 3.3×10⁻⁴, 4×10⁻⁴, 5×10⁻⁴, 6×10⁻⁴, 7×10⁻⁴, 8×10⁻⁴, 9×10⁻⁴, 1×10⁻³, 1.1×10⁻³, 1.2×10⁻³, 1.3×10⁻³, or 1.4×10⁻³.

Because the addition of the second solid electrolyte can improve the low-temperature discharge performance of the battery, the operating platform voltage of the battery at a low temperature can be improved to some extent. Therefore, when the content of the second solid electrolyte in the positive electrode plate is relatively high, the operating platform voltage of the battery can be improved to a certain extent, and it is not necessary to improve the operating platform voltage by other means to ensure that it is within an appropriate range; otherwise, a higher operating platform voltage leads to a lower energy density of the battery. However, when the content of the second solid electrolyte in the positive electrode plate is relatively low, the addition of the second solid electrolyte cannot effectively improve the operating platform voltage of the battery, and other means are still needed to improve the operating platform voltage to ensure the low-temperature discharge performance of the battery. When the two satisfy a specific relationship, the battery can further achieve a balance between a high energy density and low-temperature discharge performance.

In the present disclosure, the mass content of the element M² in the positive electrode active coating layer c3 can range from 500 ppm to 2000 ppm, e.g., 500 ppm, 600 ppm, 700 ppm, 800 ppm, 900 ppm, 1000 ppm, 1100 ppm, 1200 ppm, 1300 ppm, 1400 ppm, 1500 ppm, 1600 ppm, 1700 ppm, 1800 ppm, 1900 ppm, or 2000 ppm. The mass content of the element M² in the positive electrode active coating layer c3 can be determined by testing with a conventional method in the art, e.g., by ICP-OES. The specific test method is as follows: after a battery is discharged to 0% SOC, a positive electrode plate is disassembled, taken out and soaked in the solvent DMC for 12 h; and the positive electrode plate is then rinsed with the solvent DMC to remove a lithium salt adhered thereto and calcined in a muffle furnace at 400° C. for 3 h, the positive electrode active coating layer is then gently scraped off the surface of the positive electrode current collector, and the mass content (in ppm, i.e., parts per million) of the element M² is measured by ICP-OES. The specific operation method is carried out according to GB/T 30902-2014. “The mass content of the element M² in the positive electrode active coating layer c3” refers to the mass content of at least one element M² in the second solid electrolyte in the positive electrode active coating layer. For example, when the second solid electrolyte is lithium lanthanum zirconium tantalum oxide, the lithium lanthanum zirconium tantalum oxide includes three elements M²: La, Zr, and Ta, and thus, c2 means that the mass content of at least one of the element La, the element Zr, or the element Ta in the positive electrode active coating layer c3 satisfies the above relationship.

In the present disclosure, an average particle sizes of the first solid electrolyte and the second solid electrolyte can each independently range from 500 nm to 3 μm, e.g., 500 nm, 600 nm, 700 nm, 800 nm, 900 nm, 1 μm, 1.1 μm, 1.2 μm, 1.3 μm, 1.4 μm, 1.5 μm, 1.6 μm, 1.7 μm, 1.8 μm, 1.9 μm, or 2 μm.

In one example, the average particle sizes of the first solid electrolyte and the second solid electrolyte each independently ranges from 1 μm to 2 μm.

The average particle size of the first solid electrolyte, when within a specific range, can match the average particle size of the primary spherical particle of the silicon-carbon material, thereby increasing the electrical connection of the silicon-carbon material in the negative electrode plate, facilitating further improvement in the operating platform voltage of the battery, thus improving the low-temperature discharge performance of the battery.

In the present disclosure, the average particle sizes of the first solid electrolyte and the second solid electrolyte can be determined by testing with a conventional method in the art. For example, after a battery is discharged to 0% SOC, a positive electrode plate and a negative electrode plate are disassembled, taken out and soaked in the solvent DMC for 12 h, the positive electrode plate and the negative electrode plate are then rinsed with the solvent DMC to remove lithium salts adhered thereto; the positive electrode plate and the negative electrode plate are cut by argon ion grinder CP laser, then observed by SEM, and measured at a magnification of 5K; and at least 20 first solid electrolyte and second solid electrolyte particles are randomly selected to measure the particle size of each particle, and the average value is taken. If the number of particles is less than 20 at the magnification of 5K, another microscope image is taken until the 20 particles are measured.

In the present disclosure, the lithium-ion secondary battery further includes an electrolyte solution. The electrolyte solution can include vinylene carbonate (VC) and propylene carbonate (PC).

VC is an unsaturated additive with good film-forming properties, which can preferentially undergo reduction and decomposition at the negative electrode to participate in the formation of an SEI film, which plays a role in protecting the interface stability between the silicon-carbon material and the electrolyte solution. The SEI film derived from the reduction and decomposition of VC is rich in some highly elastic polymers, so it can help to suppress the volume expansion of the silicon-carbon material during cycling and ensures the efficient migration of lithium ions in the SEI film while improving the cycling stability, thus improving the low-temperature discharge performance of the battery. PC can improve the fluidity of the electrolyte solution, which is beneficial to the infiltration of the electrolyte solution into the battery. PC, when used in combination with VC, can further improve the low-temperature discharge performance of the battery.

In the present disclosure, a sum of a mass contents of VC and PC in the electrolyte solution can range from 10% to 40%, e.g., 10%, 15%, 20%, 25%, 30%, 35%, or 40%.

In one example, the sum of the mass contents of VC and PC in the electrolyte solution ranges from 10% to 25%.

In the present disclosure, a mass content of VC in the electrolyte solution can range from 0.1% to 10%, e.g., 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, or 10%.

In the present disclosure, the mass contents of VC and PC in the electrolyte solution can be determined by testing with a conventional method in the art, for example, by gas chromatography (GC).

In the present disclosure, the electrolyte solution can also include at least one of organic solvents, lithium salts, and additives conventionally used in the art.

Silicon-doped batteries, especially wound batteries, undergo volume expansion with the progress of the charging and discharging process, leading to the breakage of the positive electrode current collector. After research, it has been found that the reasons for the above problems lie in: a wound battery includes arcuate regions at both ends and a flat straight region connected to the arcuate regions at both ends, so that due to the special wound structure of the arcuate regions, the volume thereof is compressed, resulting in stress concentration; in addition, the silicon-carbon material has a relatively large volume expansion during charging, which further cause the volume of the arcuate regions to be severely compressed. Moreover, since the strength of the positive electrode current collector is significantly lower than that of the negative electrode current collector, the positive electrode plate in the arcuate regions suffers from plate breakage. The occurrence of plate breakage significantly reduces the cycling stability of the battery and seriously affects the low-temperature discharge performance of the battery.

The inventors of the present disclosure firstly adjusted the relationship between the radius of the arcuate regions and the thickness of the jelly roll to address the problem of plate breakage in the arcuate regions. This is because during the winding of the battery, due to the winding tension, the stress in the arcuate regions result in the electrode plate being tensioned, leading to stress accumulation in the arcuate regions, which cannot be effectively released. In addition, this stress leads to uneven stress distribution in the arcuate regions and the flat straight region, resulting in the radius R of the arcuate regions being smaller than ½ of the thickness of the jelly roll. Thus, the ratio r (i.e., r=2R/T) of the radius R of the arcuate regions to half the thickness of the jelly roll is usually less than 0.9. However, by controlling the ratio r (i.e., r=2R/T) of the radius R of the arcuate regions to half the thickness T/2 of the jelly roll to be 0.9-1.1, the arcuate regions can have a certain stress release space, thus alleviating the stress concentration problem in the arcuate regions, and the stress release space is not too large; otherwise, it may affect the electrical contact in the battery and thus be detrimental to the low-temperature discharge performance.

Secondly, the low-temperature discharge performance of the battery is further improved by adjusting r and Z. In a certain range, the smaller the r, the more uneven the stress in the arcuate regions and the flat straight region, and the less sufficient the stress release in the arcuate regions. During the charging and expansion process of the battery, the stress in the arcuate region intensifies, which makes the tensile strength of the arcuate region decrease sharply along the length direction of the positive electrode plate, seriously affecting the low-temperature discharge performance of the battery. On the contrary, the greater the r, the more uniform the stress in the arcuate regions and the flat straight region, and the less likely the positive electrode plate in the arcuate regions undergo plate breakage during the charging and discharging process of the battery. Z can reflect the structural abrupt change of the negative electrode. The greater the Z, the later the structural abrupt change of the negative electrode starts, and the smaller the subsequent volume expansion. On the contrary, the smaller the Z, the earlier the structural abrupt change of the negative electrode begins, and the greater the subsequent volume expansion. Therefore, it is necessary to limit the relationship between the two, so that the low-temperature discharge performance of the battery can be further improved and the problem of plate breakage in the arcuate regions can be addressed.

In the present disclosure, the lithium-ion secondary battery includes a jelly roll. The jelly roll includes the negative electrode plate, and the jelly roll further includes the positive electrode plate. The jelly roll includes an arcuate region and a flat straight region connected to the arcuate region; and a ratio of a radius R of the arcuate region to half a thickness T/2 of the jelly roll is r, and r and Z satisfy: 0.54≤r×Z≤0.825, e.g., 0.54, 0.55, 0.6, 0.65, 0.7, 0.75, 0.8, or 0.825.

In one example, 0.59≤r×Z≤0.73.

In the present disclosure, the radius R of the arcuate regions and the thickness T of the jelly roll have conventional meanings in the art. FIG. 3 is a schematic view showing the structure of a jelly roll in an example of the present disclosure. As can be seen from the figure, the jelly roll has arcuate regions 10 and a flat straight region 20 connected to the arcuate regions 10. The thickness T of the jelly roll refers to the dimension of the middle position of the jelly roll in the thickness direction of the negative electrode plate. The radius R of the arcuate regions refers to the shortest distance from the outermost side of the arcuate regions to the innermost side of the arcuate regions in the direction perpendicular to the thickness direction of the jelly roll.

In the present disclosure, r ranges from 0.9 to 1.1, e.g., 0.9, 0.91, 0.92, 0.93, 0.94, 0.95, 0.96, 0.97, 0.98, 0.99, 1, 1.01, 1.02, 1.03, 1.04, 1.05, 1.06, 1.07, 1.08, 1.09, or 1.1.

In the present disclosure, the arcuate region includes a plurality of layers of arcs, an arc near a winding center is an inner arc, and an arc away from the winding center is an outer arc. The positive electrode plate includes a positive electrode current collector and the positive electrode active coating layer located on at least one surface of the positive electrode current collector. The positive electrode plate includes a double-sided coating region and a single-sided coating region.

In the present disclosure, a tensile strength of the positive electrode plate in the flat straight region in a width direction is S1. In the arc with the double-sided coating region, the tensile strength of the positive electrode plate at the outermost arc and in the double-sided coating region along the length direction is S2. As shown in FIG. 3, the part framed in the dotted line frame in the figure is “in the arc with the double-sided coating region, the positive electrode plate at the outermost arc and in the double-sided coating region”.

In the present disclosure, a compressive strength of the positive electrode plate S is S2/S1, and S and Z satisfy: 0.6≤Z/S≤2, e.g., 0.6, 0.7, 0.8, 0.9, 1, 1.1, 1.2, 1.3, 1.4, 1.5, 1.6, 1.7, 1.8, 1.9, or 2.

In one example, 0.81≤Z/S≤1.46.

The compressive strength of the positive electrode plate S can indicate the degree of damage to the positive electrode plate in the arcuate regions in the length direction. The closer to 1 the S, the lower the degree of damage to the current collector in the arcuate regions and the less likely to break; otherwise, the higher the degree of damage to the arcuate regions and the more likely to occur. In addition, Z can reflect the structural abrupt change of the negative electrode. The greater the Z, the later the structural abrupt change of the negative electrode starts, the smaller the subsequent volume expansion, and the smaller the compressional force on the positive electrode plate; on the contrary, the smaller the Z, the earlier the structural abrupt change of the negative electrode begins, the greater the subsequent volume expansion, and the greater the compressional force on the positive electrode plate. The source of damage in the arcuate regions is relatively complex and is closely related to the winding tension during the winding process, the gap between the electrode plates in the arcuate regions, the number of folds of the jelly roll, etc. Defining the relationship between S and Z can prevent the occurrence of plate breakage in the arcuate regions during the charging and discharging process of the battery.

In the present disclosure, S can range from 0.4 to 1, e.g., 0.4, 0.5, 0.6, 0.7, 0.8, 0.9, or 1.

In the present disclosure, S1 can range from 150 MPa to 300 MPa, e.g., 150 MPa, 160 MPa, 170 MPa, 180 MPa, 190 MPa, 200 MPa, 210 MPa, 220 MPa, 230 MPa, 240 MPa, 250 MPa, 260 MPa, 270 MPa, 280 MPa, 290 MPa, or 300 MPa. S2 can be 90-250 MPa, e.g., 90 MPa, 100 MPa, 110 MPa, 120 MPa, 130 MPa, 140 MPa, 150 MPa, 160 MPa, 170 MPa, 180 MPa, 190 MPa, 200 MPa, 210 MPa, 220 MPa, 230 MPa, 240 MPa, or 250 MPa.

In the present disclosure, S1 and S2 can be determined by testing with a conventional method in the art. For example, after a battery is discharged to 0% SOC, a positive electrode plate is disassembled, taken out and soaked in the solvent DMC for 12 h, the positive electrode plate is then rinsed with the solvent DMC to remove a lithium salt adhered thereto; the positive electrode plate (with a positive electrode active coating layer) in a flat straight region is cut with a cutter to obtain a sample to be tested, wherein the cutting size in the length direction of the positive electrode plate is 15 mm (i.e., the short side of the sample to be tested), and the cutting size in the width direction of the positive electrode plate is more than 50 mm (i.e., the long side of the sample to be tested); and the sample to be tested is subjected to a tensile test using model WD-D3 electronic universal tester (with an accuracy grade of 0.5 and a precision of ±1% of the indicated value) with a gauge length set to 50 mm and a speed set to 10 mm/min to obtain the maximum tensile stress, i.e. S1. The positive electrode plate (with a positive electrode active coating layer) in a specific region is cut with a cutter to obtain a sample to be tested, wherein the cutting size in the length direction of the positive electrode plate is more than 50 mm (i.e., the long side of the sample to be tested), and the cutting size in the width direction of the positive electrode plate is 15 mm (i.e., the short side of the sample to be tested); and the sample to be tested can be tested by the above method to obtain S2.

In the present disclosure, an outer surface of the negative electrode active coating layer can include first recesses. The surface of the negative electrode active coating layer is provided with first recesses. The first recesses can shorten the contact distance between the electrolyte solution and the negative electrode active material, reduce the polarization impedance in the thickness direction of the negative electrode plate, and improve the kinetic performance of the negative electrode plate, thus improving the low-temperature discharge performance of the battery.

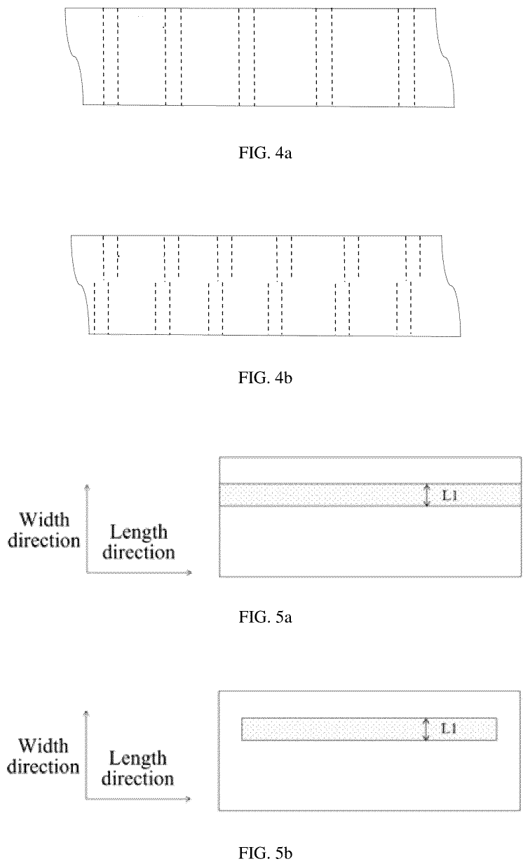

In the present disclosure, the first recesses can include either recessed holes or grooves. The first recesses can be achieved by laser drilling or scribing technology. When the first recesses are grooves, the grooves can be arranged either continuously or in segments. FIGS. 4a and 4b are schematic views (top view) showing grooves on a surface of a negative electrode plate in an example of the present disclosure, wherein in FIG. 4a, the grooves are arranged continuously; and in FIG. 4b, the grooves are arranged in segments. As can be seen from the figure, the surface of the negative electrode plate (i.e., the surface of the negative electrode active coating layer) has a plurality of grooves. In FIG. 4a, the grooves are arranged continuously in the width direction of the negative electrode plate, and in FIG. 4b, the grooves are arranged in segments in the width direction of the negative electrode plate. It will be appreciated that FIGS. 4a and 4b only show the case where the grooves are arranged in the width direction of the negative electrode plate; however, the grooves can also be arranged in the length direction of the negative electrode plate.

In the present disclosure, a depth of the first recesses can range from 5 μm to 40 μm, e.g., 5 μm, 10 μm, 15 μm, 20 μm, 25 μm, 30 μm, 35 μm, or 40 μm. The depth of the first recesses has the conventional meaning in the art and refers to the perpendicular distance from the lowest point in the first recesses to the surface of the negative electrode plate. The depth of the first recesses can be measured by testing with a conventional method in the art. For example, by a 3D profile meter, the depths of all the first recesses or at least 20 first recesses on the surface of the negative electrode active coating layer are measured, and the average value is taken.

In one example, the depth of the first recesses ranges from 15 μm to 30 μm.

In the present disclosure, a width of the first recesses can range from 40 μm to 200 μm, e.g., 40 μm, 50 μm, 60 μm, 70 μm, 80 μm, 90 μm, 100 μm, 150 μm, or 200 μm.

In one example, the width of the first recesses ranges from 60 μm to 100 μm.

When the first recesses are recessed holes, the width of the first recesses refers to the hole diameter of the recessed holes. The hole diameter of the recessed holes has the conventional meaning in the art. When the shape of the orthographic projection of the recessed holes on the surface of the negative electrode plate is a “regular circle”, the hole diameter of the recessed holes is the diameter of the regular circle; and when the shape of the orthographic projection of the recessed holes on the surface of the negative electrode plate is an “irregular circle” (e.g., an ellipse or an irregular curve polygon), the hole diameter of the recessed holes is the diameter of an equivalent circle with an area equal to that of the “irregular circle”. The hole diameter of the recessed holes can be determined by testing with a conventional means in the art. For example, by a 3D profile meter, all or at least 10 recessed holes are selected, the hole diameters thereof are measured, and the average value is taken.

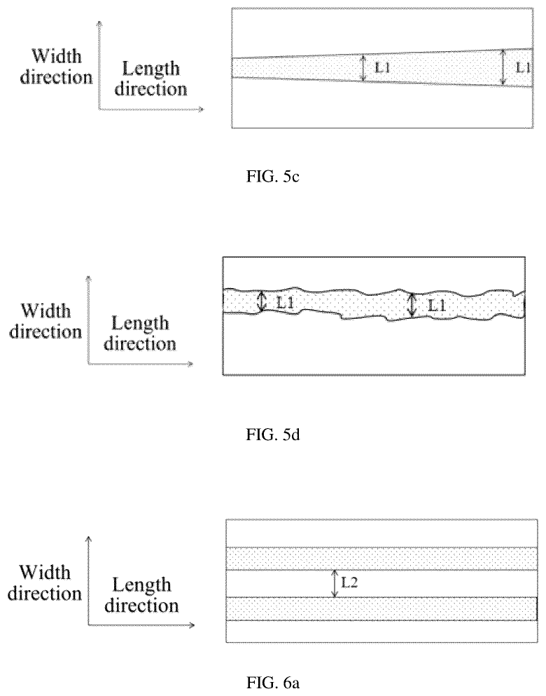

When the first recesses are grooves, the width of the first recesses refers to the width of the grooves. The width of the grooves has the conventional meaning in the art. The orthographic projection of the grooves on the surface of the negative electrode plate includes two long sides. The width of the grooves refers to the average distance from one long side to the other long side in the length direction or width direction of the negative electrode plate. FIG. 5a-5d are schematic views showing the width of grooves in an example of the present disclosure. In FIGS. 5a-5c, two long sides of the groove are straight lines, and in FIG. 5d, two long sides of the groove are curved lines. In FIGS. 5a and 5b, the two long sides are arranged in parallel, and therefore, in the width direction of the negative electrode plate, the perpendicular distance from any point on one long side to the other long side is identical. In this case, the width of the grooves is the perpendicular distance L1 from any point on one long side to the other long side in the length direction or width direction of the negative electrode plate. In FIG. 5c, the two long sides of a groove are straight lines, but are not arranged in parallel. Therefore, in the width direction, the distance from any point on one long side to the other long side is not identical. In this case, the width of the groove can be an average value. That is to say, on a long side, based on the length of the side, 50 points are selected at equal distance (that is, the inter-point distance is identical, and selecting points in this way can make the calculation result more accurate), the width L1 corresponding to each point is measured, and the average value is taken to obtain the width of the groove. In FIG. 5d, the two long sides are curves. Therefore, in the width direction, the size from any point on one long side to the other long side is not identical. In this case, the width of the groove can also be an average value. That is to say, 50 points are randomly selected on one long side (since the two long sides in FIG. 5d are curves, the relationship between the two long sides in FIG. 5c does not exist, and therefore, 50 points can be randomly selected for measurement), the width L1 corresponding to each point is measured, and the average value is taken to obtain the width of the groove. The width of the grooves can be determined by testing with a conventional means in the art. For example, the widths of all the grooves or at least 5 grooves on the surface of the negative electrode active coating layer are measured by testing with a 3D profile meter, and the average value is taken.

In the present disclosure, a spacing between the first recesses can range from 0.5 mm to 5 mm, e.g., 0.5 mm, 0.6 mm, 0.7 mm, 0.8 mm, 0.9 mm, 1 mm, 1.5 mm, 2 mm, 2.5 mm, 3 mm, 3.5 mm, 4 mm, 4.5 mm, or 5 mm.

In one example, the spacing between the first recesses ranges from 0.8 mm to 1.5 mm.

When the first recesses are recessed holes, the spacing between the first recesses refers to the spacing between the recessed holes. The spacing between the recessed holes has the conventional meaning in the art. It refers to the shortest distance between the edges of two adjacent recessed holes on the surface of the negative electrode plate, and the spacing between the recessed holes can be determined by testing with a conventional means in the art. For example, by a 3D profile meter, all or at least 10 groups of adjacent recessed holes are selected, the spacing is measured, and the average value is taken.

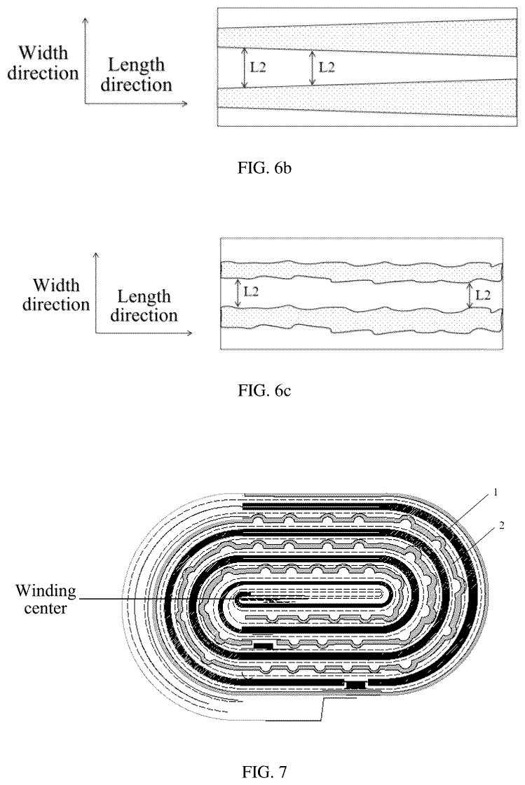

When the first recesses are grooves, the spacing between the first recesses refers to the spacing between the grooves. It can be understood that when there is only one groove on the surface of the negative electrode plate, no groove spacing exists. The spacing between the grooves has the conventional meaning in the art and refers to the average distance between two adjacent long sides of two adjacent grooves in the length direction or width direction of the negative electrode plate. FIG. 6a-6c are schematic views showing the spacing of grooves in an example of the present disclosure, wherein FIG. 6a shows the case where two adjacent long sides are straight and parallel, FIG. 6b shows the case where two adjacent long sides are straight and non-parallel, and FIG. 6c shows the case where two adjacent long sides are curved. In FIG. 6a, two adjacent long sides are straight lines and arranged in parallel, and therefore, in the width direction, the distance from any point on one long side to the other long side is identical. In this case, the spacing between the grooves is the distance L2 from any point on one long side to the other long side in the width direction. In FIG. 6b, two adjacent long sides are straight lines, but are not arranged in parallel. Therefore, in the width direction, the distance from any point on one long side to the other long side is not identical. In this case, the spacing between the grooves can be an average value. That is to say, on a long side, based on the length of the side, 50 points are selected at equal distance (that is, the inter-point distance is identical, and selecting points in this way can make the calculation result more accurate), the width L2 corresponding to each point is measured, and the average value is taken to obtain the spacing. In FIG. 6c, two adjacent long sides are curves. Therefore, in the width direction, the distance from any point on one long side to the other long side is not identical. In this case, the spacing between the grooves can also be an average value. That is to say, 50 points are randomly selected on one long side (since the two long sides in FIG. 6c are curves, the relationship between the two long sides in FIG. 6b does not exist, and therefore, 50 points can be randomly selected for measurement), the width L2 corresponding to each point is measured, and the average value is taken to obtain the spacing. The spacing between the grooves can be determined by testing with a conventional means in the art. For example, the spacings between all the grooves or at least 5 grooves on the surface of the negative electrode active coating layer are measured by testing with a 3D profile meter, and the average value is taken.

In the present disclosure, a length of the positive electrode active coating layer located on a first surface of the positive electrode current collector is greater than a length of the positive electrode active coating layer located on a second surface of the positive electrode current collector. It can be appreciated that when coating the positive electrode plate, there are a single-sided coating region and a double-sided coating region, wherein the single-sided coating region is namely a positive electrode current collector located in the region, and only the surface on one side has the positive electrode active coating layer; and the double-sided coating region is namely the positive electrode current collector located in the region, and the surfaces on both sides have the positive electrode active coating layer. This leads to the case where the lengths of the positive electrode active coating layers on the surfaces on both sides of the positive electrode plate are not identical. In the present disclosure, the surface of the positive electrode active coating layer on the relatively long length surface of the positive electrode current collector is defined as a first surface, and the relatively short length surface of the positive electrode active coating layer is defined as a second surface. A region where a projection of the positive electrode active coating layer located on the first surface overlaps with a projection of the positive electrode active coating layer located on the second surface in the thickness direction of the positive electrode plate is namely the double-sided coating region, and a region where the projections do not overlap is namely single-sided coating region. Due to the special structure of a wound battery, the first surface usually faces the winding center of the jelly roll, and the second surface faces away from the winding center of the jelly roll.

In the present disclosure, a surface of the positive electrode active coating layer located on the first surface includes second recesses, and a surface of the positive electrode active coating layer located on the second surface includes protrusions. Embossing the surface of the positive electrode plate can obtain a structure with recesses on one side and protrusions on the other side. The storage position of the electrolyte solution in the battery is distributed in the gap between the cell and a shell (e.g., an aluminum-plastic film) and interlayer gaps between the positive electrode plate, the negative electrode plate, and the separator. The storage of the electrolyte solution between layers mainly relies on slow infiltration by means of the pores of the electrode plates (the positive electrode plate and the negative electrode plate) and the capillary effect, which takes a longer time and is more difficult than the infiltration of the gaps between the cell and the shell. Therefore, the liquid storage capacity in the interlayer gaps between the positive electrode plate, the negative electrode plate, and the separator is relatively small. Providing the second recesses and the protrusions on the surface of the positive electrode plate can provide more liquid storage places and reduce the ion transport distance, thus reducing the polarization of the positive electrode plate and the negative electrode plate, which is beneficial to improving the low-temperature discharge performance of the battery.

Furthermore, the inventors of the present disclosure have conducted stress analysis on the positive electrode active coating layer facing and away from the winding center in the jelly roll and have found that when the first surface facing the winding center is provided with recesses and the second surface away from the winding center is provided with protrusions, this is not only beneficial to the structural stability of the positive electrode plate itself, but can also provide a better buffer space for the volume expansion of the negative electrode plate, so that the cycling life of the battery can be prolonged.

FIG. 7 is a schematic view showing the structure of a jelly roll in an example of the present disclosure. As can be seen from the figure, the surface of the positive electrode active coating layer located on the first surface includes second recesses, and the surface of the positive electrode active coating layer located on the second surface includes protrusions; and the first surface faces the winding center of the jelly roll, and the second surface faces away from the winding center of the jelly roll.

In the present disclosure, the shapes of the orthographic projections of the second recesses and the protrusions on the surface of the positive electrode plate are not limited and can be circular, elliptical, linear (including straight or wavy lines), polygonal, or other shapes.

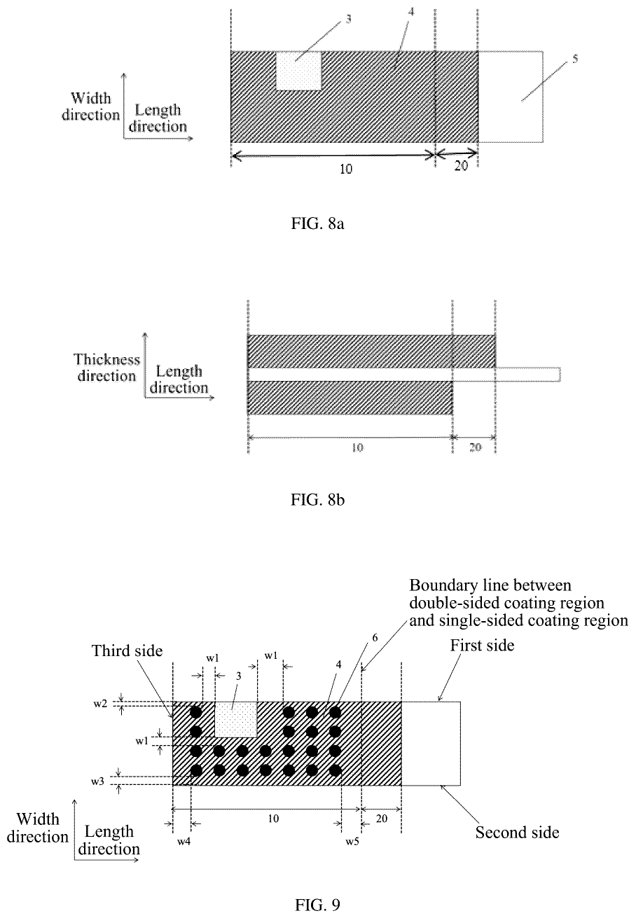

In the present disclosure, the positive electrode plate includes a positive electrode tab welding region, a pasting region, and an empty foil region. The empty foil region refers to the region on the positive electrode current collector that is not coated with the positive electrode active coating layer except the positive electrode tab welding region. The pasting region includes a double-sided coating region and a single-sided coating region. FIGS. 8a and 8b are schematic views showing the structure of a positive electrode plate in an example of the present disclosure, wherein FIG. 8a is a top view, and FIG. 8b is a cross-sectional view along the thickness direction. As can be seen from the figures, the positive electrode plate includes a positive electrode tab welding region 3, a pasting region 4, and empty foil region 5, wherein the pasting region 4 includes a double-sided coating region 10 and a single-sided coating region 20.

In one example, the second recesses and the protrusions are located on the pasting region.

In one example, the second recesses and the protrusions are located in the double-sided coating region.

In one example, the second recesses and the protrusions are located on the pasting region and located on the double-sided coating region.

In the present disclosure, a distance from the second recesses to an edge of the positive electrode tab welding region is w1, with 0 mm<w1≤10 mm, e.g., 0.1 mm, 0.5 mm, 1 mm, 2 mm, 3 mm, 4 mm, 5 mm, 6 mm, 7 mm, 8 mm, 9 mm, or 10 mm.

In the present disclosure, a distance from the second recesses to an edge of a first side of the pasting region is w2, with 2 mm≤w2≤40 mm, e.g., 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 35 mm, or 40 mm. The first side is the side where the positive electrode tab welding region is arranged.

In the present disclosure, a distance from the second recesses to an edge of a second side of the pasting region is w3, with 2 mm≤w3≤25 mm, e.g., 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, or 25 mm. The second side is a side opposite to the side where the positive electrode tab welding region is arranged.

In the present disclosure, a distance from the second recesses to an edge of a third side of the pasting region is w4, with 0 mm<w4≤20 mm, e.g., 0.1 mm, 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm. The third side is a side of the pasting region close to a winding head end.

In the present disclosure, a distance from the second recesses to a boundary line between the double-sided coating region and the single-sided coating region is w5, with 0 mm<w5≤20 mm, e.g., 0.1 mm, 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm.

By controlling w1, w2, w3, w4, and w5, it can ensure that the positive electrode plate does not shed powder, which is beneficial to improving the cycling life of the battery.

FIG. 9 is a schematic top view showing a first surface of a positive electrode plate in an example of the present disclosure. As can be seen from the figure, the first surface includes a plurality of second recesses 6, wherein the distance from the second recesses 6 to an edge of the positive electrode tab welding region 3 is w1, the distance from the second recesses 6 to the edge of the first side of the pasting region 4 is w2, the distance from the second recesses 6 to the edge of the second side of the pasting region 4 is w3, the distance from the second recesses 6 to the edge of the third side of the pasting region 4 is w4, and the distance from the second recesses 6 to the boundary line between the double-sided coating region 10 and the single-sided coating region 20 is w5.

In the present disclosure, a depth of the second recesses can range from 3 μm to 40 μm, e.g., 3 μm, 5 μm, 10 μm, 15 μm, 20 μm, 25 μm, 30 μm, 35 μm, or 40 μm. The height of the protrusions can be 3-40 μm, e.g., 3 μm, 5 μm, 10 μm, 15 μm, 20 μm, 25 μm, 30 μm, 35 μm, or 40 μm.

In one example, the depth of the second recesses ranges from 10 μm to 30 μm. The height of the protrusions is 10-30 μm.

In the present disclosure, the depth of the second recesses and the height of the protrusions have the conventional meanings in the art. The depth of the second recesses refers to the perpendicular distance from the lowest point in the second recesses to the surface of the positive electrode plate. The height of the protrusions refers to the perpendicular distance from the highest point on the protrusions to the surface of the positive electrode plate. The depth of the second recesses and the height of the protrusions can be determined by testing with a conventional method in the art. For example, by a 3D profile meter, at least 10 second recesses or 10 protrusions are selected on the positive electrode plate, the depth of each second recess and the height of the protrusion are measured, and average values are taken.

In the present disclosure, a width of the second recesses can range from 0.2 mm to 8 mm, e.g., 0.2 mm, 0.5 mm, 1 mm, 2 mm, 3 mm, 4 mm, 5 mm, 6 mm, 7 mm, or 8 mm. A width of the protrusions can range from 0.2 mm to 8 mm, e.g., 0.2 mm, 0.5 mm, 1 mm, 2 mm, 3 mm, 4 mm, 5 mm, 6 mm, 7 mm, or 8 mm.

In one example, the width of the second recesses ranges from 1 mm to 3 mm. The width of the protrusions is 1 mm to 3 mm.

In the present disclosure, when the shape of the projection of the second recesses in the thickness direction of the positive electrode plate is a regular circle, the width of the second recesses is namely the diameter of the regular circle; When the shape of the projection of the second recesses in the thickness direction of the positive electrode plate is an “irregular circle”, the width of the second recesses is namely the equivalent diameter of a circle with the same area as the irregular circle. By the same reasoning, when the shape of the projection of the protrusions in the thickness direction of the positive electrode plate is a regular circle, the width of the protrusions is namely the diameter of the regular circle; and when the shape of the projection of the protrusions in the thickness direction of the positive electrode plate is an “irregular circle”, the width of the protrusions is namely the equivalent diameter of a circle with the same area as the irregular circle. The width of the second recesses and the width of the protrusions can be determined by testing with a conventional method in the art. For example, by a 3D profile meter, at least 10 second recesses and 10 protrusions are selected on the surface of the positive electrode plate, the width of each second recess and the height of the protrusion are measured, and average values are taken.

In the present disclosure, a spacing between the second recesses can range from 0.5 mm to 8 mm, e.g., 0.5 mm, 1 mm, 2 mm, 3 mm, 4 mm, 5 mm, 6 mm, 7 mm, or 8 mm. A spacing between the protrusions can range from 0.5 mm to 8 mm, e.g., 0.5 mm, 1 mm, 2 mm, 3 mm, 4 mm, 5 mm, 6 mm, 7 mm, or 8 mm.

In one example, the spacing between the second recesses ranges from 1 mm to 3 mm. The spacing between the protrusions ranges from 1 mm to 3 mm.

In the present disclosure, the spacing between the second recesses refers to the shortest distance between the edges of the orthographic projections of two adjacent second recesses on the surface of the positive electrode plate. By the same reasoning, the spacing between the protrusions refers to the shortest distance between the edges of the orthographic projections of two adjacent protrusions on the surface of the positive electrode plate. The spacing between the second recesses and the spacing between the protrusions can be determined by testing with a conventional method in the art. For example, by a 3D profile meter, at least 10 groups of adjacent second recesses and 10 groups of adjacent protrusions are selected on the surface of the positive electrode plate, the spacing between each group of second recesses and the spacing between each group of protrusions are measured, and average values are taken.

In the present disclosure, the battery can further include a separator. The separator can be a conventional choice in the art.

It should be noted that the digital representations such as “first” and “second” in the present disclosure are only used to distinguish different materials or usage modes and do not represent the difference in order.

The present disclosure will be described in detail below by means of examples. The examples described in the present disclosure are only some, rather than all, of the examples of the present disclosure. Based on the examples in the present disclosure, all other examples obtained by those of ordinary skill in the art without involving creative effort belong to the scope of protection of the present disclosure.

In the following examples, unless otherwise specified, all the materials used are commercially available and analytically pure.

The following examples are used to illustrate the lithium-ion secondary battery of the present disclosure.

### Example 1

A battery was prepared according to the following method.

### (1) Preparation of Positive Electrode Plate

Lithium cobaltate (M included Al), a second solid electrolyte (lithium aluminum titanium phosphorus oxide, with a chemical formula of Li_{1.3}Al_{0.3}Ti_{1.7}(PO₄)₃ and an average particle size of 1.1 μm), a positive electrode conductive agent (conductive carbon black), and positive electrode binder (polyvinylidene fluoride) were mixed in a mass ratio of 96.036:0.964:1:2, then N-methylpyrrolidone (NMP) was added, and the mixture was stirred until uniform to prepare a positive electrode slurry; the above positive electrode slurry was applied to a first surface and a second surface of an aluminum foil (the coating length of the positive electrode slurry on the first surface of the aluminum foil was greater than that on the second surface), and the aluminum foil was baked and rolled to obtain a positive electrode plate with a thickness of 100 μm; a positive electrode tab welding region with a fixed size (the size of the positive electrode tab welding region in the width direction of the positive electrode plate was 20 mm) was arranged on the pasting region of the positive electrode plate, and a nickel tab was welded in the above positive electrode tab welding region by laser; furthermore, after passing over a roller, an embossing treatment was carried out from the first surface to the second surface in the double-sided coating region (with the positive electrode tab welding region being avoided) to obtain second recesses (first surface) and protrusions (second surface), wherein the shape of the orthographic projections of the second recesses and the protrusions on the surface of the positive electrode plate was circular;

wherein the mass content of the element Al in the positive electrode active coating layer was 8521 ppm, and the mass content c3 of the element M² (Ti) in the positive electrode active coating layer was 1276 ppm; the width of the second recesses was 2 mm, the depth was 20 μm, and the spacing was 2 mm; and w1 was 7 mm, w2 was 27 mm, w3 was 15 mm, w4 was 7 mm, and w5 was 7 mm.

### (2) Preparation of Negative Electrode Plate

Artificial graphite (secondary particles), a silicon-carbon material (the proportion of the number of primary spherical particles relative to the total number of the primary spherical particles and secondary spherical particles was 0.59, the average particle size of the primary spherical particles was 4.3 μm, and the mass content of the element Si in the silicon-carbon material was 50%), a negative electrode conductive agent (carbon nanotubes), a negative electrode dispersant (lithium carboxymethyl cellulose), and a negative electrode binder (polyacrylic acid) were mixed in a mass ratio of 87:10:0.4:0.1:2.5, and then deionized water was added to prepare a negative electrode slurry; the above negative electrode slurry was applied to the surfaces on both sides of a copper foil, baked, and rolled to obtain a negative electrode plate with a thickness of 110 μm; and first recesses (grooves) were made on the surface of the negative electrode plate by laser;
wherein the mass content c1 of the element Si in the negative electrode active coating layer was 5%; and the width of the grooves was 80.5 μm, the depth was 21 μm, and the spacing was 1.2 mm.

### (3) Preparation of Electrolyte Solution

In a glove box (H₂O<0.01 ppm, O₂<0.01 ppm, and Ar atmosphere), ethylene carbonate and diethyl carbonate were mixed in a weight ratio of 1:6, and 7% of PC based on the total mass of the electrolyte solution was added to obtain an organic solvent; and fluoroethylene carbonate (FEC), lithium hexafluorophosphate (LiPF₆), and VC were dissolved in the above organic solvent to obtain the electrolyte solution; wherein the mass content of FEC in the electrolyte solution was 21%, the mass content of LiPF₆ in the electrolyte solution was 12.5%, the mass content of VC in the electrolyte solution was 8%, and the sum of the mass contents of VC and PC in the electrolyte solution was 15%.

### (4) Preparation of Battery

The positive electrode plate prepared in step (1), a separator (comprising a polyethylene base film with a thickness of 4 μm, a ceramic layer with a thickness of 2 μm on a surface on one side of the base film, a polymethyl methacrylate adhesive layer with a thickness of 0.5 μm on a surface on the other side of the base film, and a polyvinylidene fluoride+polymethyl methacrylate adhesive layer with a thickness of 2.5 μm on the outer surface of the ceramic layer), and the negative electrode plate prepared in step (2) were wound to obtain a jelly roll; and after encapsulation, baking, injection, formation, secondary encapsulation, sorting, and OCV, the battery was obtained, wherein r was 0.98.

### Example 2

A battery was prepared according to the following method.

### (1) Preparation of Positive Electrode Plate

Lithium cobaltate (M included Al), a second solid electrolyte (lithium aluminum titanium phosphorus oxide, with a chemical formula of Li_{1.3}Al_{0.3}Ti_{1.7}(PO₄)₃ and an average particle size of 1.5 μm), a positive electrode conductive agent (conductive carbon black), and positive electrode binder (polyvinylidene fluoride) were mixed in a mass ratio of 96.042:0.958:1:2, then N-methylpyrrolidone (NMP) was added, and the mixture was stirred until uniform to prepare a positive electrode slurry; the above positive electrode slurry was applied to a first surface and a second surface of an aluminum foil (the coating length of the positive electrode slurry on the first surface of the aluminum foil was greater than that on the second surface), and the aluminum foil was baked and rolled to obtain a positive electrode plate with a thickness of 100 μm; a positive electrode tab welding region with a fixed size (the size of the positive electrode tab welding region in the width direction of the positive electrode plate was 20 mm) was arranged on the pasting region of the positive electrode plate, and a nickel tab was welded in the above positive electrode tab welding region by laser; furthermore, after passing over a roller, an embossing treatment was carried out from the first surface to the second surface in the double-sided coating region (with the positive electrode tab welding region being avoided) to obtain second recesses (first surface) and protrusions (second surface), wherein the shape of the orthographic projections of the second recesses and the protrusions on the surface of the positive electrode plate was circular;
wherein the mass content of the element Al in the positive electrode active coating layer was 7032 ppm, and the mass content c3 of the element M² (Ti) in the positive electrode active coating layer was 1983 ppm; the width of the second recesses was 1 mm, the depth was 10 μm, and the spacing was 1 mm; and w1 was 5 mm, w2 was 20 mm, w3 was 10 mm, w4 was 5 mm, and w5 was 5 mm.

### (2) Preparation of Negative Electrode Plate

Artificial graphite (secondary particles), a silicon-carbon material (the proportion of the number of primary spherical particles relative to the total number of the primary spherical particles and secondary spherical particles was 0.35, the average particle size of the primary spherical particles was 3.3 μm, and the mass content of the element Si in the silicon-carbon material was 50%), a negative electrode conductive agent (carbon nanotubes), a negative electrode dispersant (lithium carboxymethyl cellulose), and a negative electrode binder (polyacrylic acid) were mixed in a mass ratio of 87:10:0.4:0.1:2.5, and then deionized water was added to prepare a negative electrode slurry; the above negative electrode slurry was applied to the surfaces on both sides of a copper foil, baked, and rolled to obtain a negative electrode plate with a thickness of 110 μm; and first recesses (grooves) were made on the surface of the negative electrode plate by laser;
wherein the mass content c1 of the element Si in the negative electrode active coating layer was 5%; and the width of the grooves was 61.3 μm, the depth was 15.6 μm, and the spacing was 0.8 mm.

### (3) Preparation of Electrolyte Solution

In a glove box (H₂O<0.01 ppm, O₂<0.01 ppm, and Ar atmosphere), ethylene carbonate and diethyl carbonate were mixed in a weight ratio of 1:6, and 15% of PC based on the total mass of the electrolyte solution was added to obtain an organic solvent; and fluoroethylene carbonate (FEC), lithium hexafluorophosphate (LiPF₆), and VC were dissolved in the above organic solvent to obtain the electrolyte solution; wherein the mass content of FEC in the electrolyte solution was 21%, the mass content of LiPF₆ in the electrolyte solution was 12.5%, the mass content of VC in the electrolyte solution was 10%, and the sum of the mass contents of VC and PC in the electrolyte solution was 25%.

### (4) Preparation of Battery

The positive electrode plate prepared in step (1), a separator (comprising a polyethylene base film with a thickness of 4 μm, a ceramic layer with a thickness of 2 μm on a surface on one side of the base film, a polymethyl methacrylate adhesive layer with a thickness of 0.5 μm on a surface on the other side of the base film, and a polyvinylidene fluoride+polymethyl methacrylate adhesive layer with a thickness of 2.5 μm on the outer surface of the ceramic layer), and the negative electrode plate prepared in step (2) were wound to obtain a jelly roll; and after encapsulation, baking, injection, formation, secondary encapsulation, sorting, and OCV, the battery was obtained, wherein r was 0.92.

### Example 3

A battery was prepared according to the following method.

### (1) Preparation of Positive Electrode Plate

Lithium cobaltate (M included Al), a second solid electrolyte (lithium aluminum titanium phosphorus oxide, with a chemical formula of Li_{1.3}Al_{0.3}Ti_{1.7} (PO₄)₃ and an average particle size of 2 μm), a positive electrode conductive agent (conductive carbon black), and positive electrode binder (polyvinylidene fluoride) were mixed in a mass ratio of 96.03:0.97:1:2, then N-methylpyrrolidone (NMP) was added, and the mixture was stirred until uniform to prepare a positive electrode slurry; the above positive electrode slurry was applied to a first surface and a second surface of an aluminum foil (the coating length of the positive electrode slurry on the first surface of the aluminum foil was greater than that on the second surface), and the aluminum foil was baked and rolled to obtain a positive electrode plate with a thickness of 100 μm; a positive electrode tab welding region with a fixed size (the size of the positive electrode tab welding region in the width direction of the positive electrode plate was 20 mm) was arranged on the pasting region of the positive electrode plate, and a nickel tab was welded in the above positive electrode tab welding region by laser; furthermore, after passing over a roller, an embossing treatment was carried out from the first surface to the second surface in the double-sided coating region (with the positive electrode tab welding region being avoided) to obtain second recesses (first surface) and protrusions (second surface), wherein the shape of the orthographic projections of the second recesses and the protrusions on the surface of the positive electrode plate was circular;
wherein the mass content of the element Al in the positive electrode active coating layer was 9967 ppm, and the mass content c3 of the element M² (Ti) in the positive electrode active coating layer was 507 ppm; the width of the second recesses was 3 mm, the depth was 30 μm, and the spacing was 3 mm; and w1 was 9 mm, w2 was 34 mm, w3 was 20 mm, w4 was 10 mm, and w5 was 10 mm.

### (2) Preparation of Negative Electrode Plate

Artificial graphite (secondary particles), a silicon-carbon material (the proportion of the number of primary spherical particles relative to the total number of the primary spherical particles and secondary spherical particles was 0.79, the average particle size of the primary spherical particles was 4.9 μm, and the mass content of the element Si in the silicon-carbon material was 50%), a negative electrode conductive agent (carbon nanotubes), a negative electrode dispersant (lithium carboxymethyl cellulose), and a negative electrode binder (polyacrylic acid) were mixed in a mass ratio of 87:10:0.4:0.1:2.5, and then deionized water was added to prepare a negative electrode slurry; the above negative electrode slurry was applied to the surfaces on both sides of a copper foil, baked, and rolled to obtain a negative electrode plate with a thickness of 110 μm; and first recesses (grooves) were made on the surface of the negative electrode plate by laser;
wherein the mass content c1 of the element Si in the negative electrode active coating layer was 5%; and the width of the grooves was 99.1 μm, the depth was 29.5 μm, and the spacing was 1.5 mm.

### (3) Preparation of Electrolyte Solution

In a glove box (H₂O<0.01 ppm, O₂<0.01 ppm, and Ar atmosphere), ethylene carbonate and diethyl carbonate were mixed in a weight ratio of 1:6, and 5% of PC based on the total mass of the electrolyte solution was added to obtain an organic solvent; and fluoroethylene carbonate (FEC), lithium hexafluorophosphate (LiPF₆), and VC were dissolved in the above organic solvent to obtain the electrolyte solution; wherein the mass content of FEC in the electrolyte solution was 21%, the mass content of LiPF₆ in the electrolyte solution was 12.5%, the mass content of VC in the electrolyte solution was 5%, and the sum of the mass contents of VC and PC in the electrolyte solution was 10%.

### (4) Preparation of Battery

The positive electrode plate prepared in step (1), a separator (comprising a polyethylene base film with a thickness of 4 μm, a ceramic layer with a thickness of 2 μm on a surface on one side of the base film, a polymethyl methacrylate adhesive layer with a thickness of 0.5 μm on a surface on the other side of the base film, and a polyvinylidene fluoride+polymethyl methacrylate adhesive layer with a thickness of 2.5 μm on the outer surface of the ceramic layer), and the negative electrode plate prepared in step (2) were wound to obtain a jelly roll; and after encapsulation, baking, injection, formation, secondary encapsulation, sorting, and OCV, the battery was obtained, wherein r was 1.03.

### Example 4 Group

This group of examples was used to verify the influence of the change of “the mass content c1 of the element Si in the negative electrode active coating layer”.

This group of examples was carried out with reference to Example 1, except that c1 was adjusted by changing the mass contents of the graphite material and the silicon-carbon material in the negative electrode slurry, specifically as follows:
in Example 4a, artificial graphite, a silicon-carbon material, a negative electrode conductive agent, a negative electrode dispersant, and a negative electrode binder were mixed in a mass ratio of 90:7:0.4:0.1:2.5; wherein c1 was 3.5%;
in Example 4b, artificial graphite, a silicon-carbon material, a negative electrode conductive agent, a negative electrode dispersant, and a negative electrode binder were mixed in a mass ratio of 84:13:0.4:0.1:2.5; wherein c1 was 6.5%;
in Example 4c, artificial graphite, a silicon-carbon material, a negative electrode conductive agent, a negative electrode dispersant, and a negative electrode binder were mixed in a mass ratio of 94:3:0.4:0.1:2.5; wherein c1 was 1.5%; and
in Example 4d, artificial graphite, a silicon-carbon material, a negative electrode conductive agent, a negative electrode dispersant, and a negative electrode binder were mixed in a mass ratio of 82:15:0.4:0.1:2.5; wherein c1 was 7.5%.

### Example 5 Group

This group of examples was used to verify the influence of the change of “the average particle size of the primary spherical particles”.

This group of examples was carried out with reference to Example 1, except that the average particle size of the primary spherical particles was changed, specifically as follows:
in Example 5a, the average particle size of the primary spherical particles was 1.2 μm; and
in Example 5b, the average particle size of the primary spherical particles was 6 μm.

### Example 6 Group

This group of examples was used to verify the influence of the change of “the proportion of the number of the primary spherical particles relative to the total number of the primary spherical particles and the secondary spherical particles”.

This group of examples was carried out with reference to Example 1, except that the proportion of the number of the primary spherical particles was changed, specifically as follows:
in Example 6a, the proportion of the number of the primary spherical particles relative to the total number of the primary spherical particles and the secondary spherical particles was 0.12;
in Example 6b, the proportion of the number of the primary spherical particles relative to the total number of the primary spherical particles and the secondary spherical particles was 0.89; and
in Example 6c, the silicon-carbon material is entirely made up of primary spherical particles, that is, the proportion of the number of the primary spherical particles relative to the total number of the primary spherical particles and the secondary spherical particles was 1.

### Example 7

This example was carried out with reference to Example 1, except that the artificial graphite was primary particles, and the average particle size was 6.1 μm.

### Example 8 Group

This group of examples was used to verify the influence of “the addition of the first solid electrolyte to the negative electrode active coating layer”.

This group of examples was carried out with reference to Example 1, except that a first solid electrolyte was added to the negative electrode active coating layer, and no second solid electrolyte was added to the positive electrode active coating layer, specifically as follows:

### Example 8a

Preparation of positive electrode plate: Lithium cobaltate, a positive electrode conductive agent, and a positive electrode binder were mixed in a mass ratio of 97:1:2;

Preparation of negative electrode plate: Artificial graphite, a silicon-carbon material, a first solid electrolyte (lithium lanthanum zirconium tantalum oxide, with a chemical formula of Li_{6.5}La₃Zr_{1.5}Ta_{0.5}O₁₂ and an average particle size of 1.3 μm), a negative electrode conductive agent, a negative electrode dispersant, and a negative electrode binder were mixed in a mass ratio of 86:10:1:0.4:0.1:2.5;
wherein the mass content c2 of the element M¹ (Zr) in the negative electrode active coating layer was 0.25%, and c2/c1 was 0.05;

### Example 8b

Preparation of positive electrode plate: Lithium cobaltate, a positive electrode conductive agent, and a positive electrode binder were mixed in a mass ratio of 97:1:2;

Preparation of negative electrode plate: Artificial graphite, a silicon-carbon material, a first solid electrolyte (lithium lanthanum zirconium tantalum oxide, with a chemical formula of Li_{6.5}La₃Zr_{1.5}Ta_{0.5}O₁₂ and an average particle size of 1.6 μm), a negative electrode conductive agent, a negative electrode dispersant, and a negative electrode binder were mixed in a mass ratio of 86.5:10:0.5:0.4:0.1:2.5;
wherein the mass content c2 of the element M¹ (Zr) in the negative electrode active coating layer was 0.1%, and c2/c1 was 0.02;

### Example 8c

Preparation of positive electrode plate: lithium cobaltate, a positive electrode conductive agent, and a positive electrode binder were mixed in a mass ratio of 97:1:2;

Preparation of negative electrode plate: artificial graphite, a silicon-carbon material, a first solid electrolyte (lithium lanthanum titanium oxide, with a chemical formula of Li_{0.3}La_{0.567}TiO₃ and an average particle size of 2 μm), a negative electrode conductive agent, a negative electrode dispersant, and a negative electrode binder were mixed in a mass ratio of 85:10:2:0.4:0.1:2.5;
wherein the mass content c2 of the element M¹ (La) in the negative electrode active coating layer was 0.5%, and c2/c1 was 0.1.

### Example 9 Group

This group of examples was used to verify the influence of the change of “the average particle size of the first solid electrolyte”.

This group of examples was carried out with reference to Example 8a, except that the average particle size of the first solid electrolyte was changed, specifically as follows:
in Example 9a, the average particle size of the first solid electrolyte was 500 nm; and
in Example 9b, the average particle size of the first solid electrolyte was 2.7 μm.

### Example 10

This example was used to verify the influence of the change of “the type of the first recesses”.

This example was carried out with reference to Example 1, except that recessed holes were made on the surface of the negative electrode plate by laser, wherein the width of the recessed holes was 76.5 μm, the depth was 25.3 μm, and the spacing was 0.5 mm.

### Example 11 Group

This group of examples was used to verify the influence of the change of “the mass content of the element Al in the positive electrode active coating layer”.

This group of examples was carried out with reference to Example 1, except that the mass content of the element Al in the positive electrode active coating layer was changed, specifically as follows:
in Example 11a, the mass content of the element Al in the positive electrode active coating layer was 6821 ppm; and
in Example 11b, the mass content of the element Al in the positive electrode active coating layer was 14767 ppm.

### Example 12

This example was used to verify the influence of “whether the second recesses were located on the surface of positive electrode active coating layer on the first surface and whether the protrusions were located on the surface of positive electrode active coating layer on the second surface”.

This example was carried out with reference to Example 1, except that an embossing treatment was carried out from the second surface to the first surface, that is, the surface of the positive electrode active coating layer located on the second surface had second recesses, and the surface of the positive electrode active coating layer located on the first surface had protrusions.

### Example 13

This example was used to verify the influence of “no second recesses and protrusions arranged on the surface of the positive electrode active coating layer”.

This example was carried out with reference to Example 1, except that no embossing treatment was carried out.

### Example 14

This example was used to verify the influence of “whether the single-sided coating region had second recesses”.

This example was carried out with reference to Example 1, except that an embossing treatment was carried out on the single-sided coating region and the double-sided coating region (with the positive electrode tab welding region being avoided).

### Example 15 Group

This group of examples was used to verify the influence of the change of “w1, w2, w3, w4, and w5”.

This group of examples was carried out with reference to Example 1, except that w1, w2, w3, w4, and w5 were changed, specifically as follows:
in Example 15a, w1 was 0.5 mm, w2 was 2 mm, w3 was 2 mm, w4 was 0.5 mm, and w5 was 0.5 mm; and
in Example 15b, w1 was 10 mm, w2 was 40 mm, w3 was 25 mm, w4 was 20 mm, and w5 was 20 mm.

### Example 16 Group

This group of examples was used to verify the influence of the change of “VC and/or PC in the electrolyte solution”.

This group of examples was carried out with reference to Example 1, except that no VC and/or PC were added to the electrolyte solution, specifically as follows:
in Example 16a, no PC was added to the electrolyte solution;
in Example 16b, no VC was added to the electrolyte solution; and
in Example 16c, no VC and PC were added to the electrolyte solution.

### Example 17

This example was used to verify the influence of the change of “the sum of the mass contents of VC and PC in the electrolyte solution”.

This example was carried out with reference to Example 1, except that the sum of the mass contents of VC and PC in the electrolyte solution was adjusted by changing the mass content of PC in the electrolyte solution, specifically as follows: the mass content of VC in the electrolyte solution was 8%, the mass content of PC in the electrolyte solution was 32%, and the sum of the mass contents of VC and PC in the electrolyte solution was 40%.

### Example 18

This example was used to verify the influence of the change of “r”.

This group of examples was carried out with reference to Example 1, except that r was adjusted by changing the winding tension, specifically as follows: r was 0.87.

The above examples all satisfied the following conditions: the average particle size of the first particles of lithium cobaltate was 0.3-7 μm, and the average particle size of the second particles was 7.5-40 μm. The above examples, except Example 6c, all satisfied the condition that the average particle size of the secondary spherical particles of the silicon-carbon material was 3-20 μm. The examples, except Example 7, all satisfied the condition that the average particle size of the secondary particles of the graphite material was 6-20 μm.

### Comparative Example 1

This comparative example was carried out with reference to Example 1, except the mass content c1 of the element Si in the negative electrode active coating layer, specifically as follows: artificial graphite, a silicon-carbon material, a negative electrode conductive agent, a negative electrode dispersant, and a negative electrode binder were mixed in a mass ratio of 95:2:0.4:0.1:2.5; wherein c1 was 1%.

### Comparative Example 2

This comparative example was carried out with reference to Example 1, except the mass content c1 of the element Si in the negative electrode active coating layer, specifically as follows: artificial graphite, a silicon-carbon material, a negative electrode conductive agent, a negative electrode dispersant, and a negative electrode binder were mixed in a mass ratio of 79:18:0.4:0.1:2.5; wherein c1 was 9%.

### Test Example I

### (1) ZCV Curve

The batteries prepared in the examples and comparative examples were tested for ZCV curves, and the test results were recorded in Table 1, in which the test result of Comparative Example 1 was 91% and the test result of Comparative Example 2 was 48%.

### (2) Test for Tensile Strength of Positive Electrode Plate

The batteries prepared in the examples were tested for the tensile strength of the positive electrode plate, and the results were collected and recorded in Table 1.

TABLE 1

| | | | | S1 | S2 | | |
|---|---|---|---|---|---|---|---|
| | Z | c3 × Z | r × Z | (MPa) | (MPa) | S | Z/S |
| Example 1 | 66.5% | 8.49 × 10⁻⁴ | 0.65 | 220 | 150 | 0.68 | 0.98 |
| Example 2 | 66.3% | 1.31 × 10⁻³ | 0.61 | 220 | 100 | 0.45 | 1.46 |
| Example 3 | 66.5% | 3.37 × 10⁻⁴ | 0.68 | 220 | 180 | 0.82 | 0.81 |
| Example 4a | 74.8% | 9.54 × 10⁻⁴ | 0.73 | 235 | 170 | 0.72 | 1.03 |
| Example 4b | 60% | 7.66 × 10⁻⁴ | 0.59 | 205 | 150 | 0.73 | 0.82 |
| Example 4c | 86.7% | 1.11 × 10⁻³ | 0.85 | 225 | 180 | 0.8 | 1.08 |
| Example 4d | 55.5% | 7.08 × 10⁻⁴ | 0.54 | 200 | 140 | 0.7 | 0.79 |
| Example 5a | 66.2% | 8.45 × 10⁻⁴ | 0.65 | 220 | 150 | 0.68 | 0.97 |
| Example 5b | 66.2% | 8.45 × 10⁻⁴ | 0.65 | 220 | 150 | 0.68 | 0.97 |
| Example 6a | 66.3% | 8.46 × 10⁻⁴ | 0.65 | 220 | 150 | 0.68 | 0.97 |
| Example 6b | 66.7% | 8.51 × 10⁻⁴ | 0.65 | 220 | 150 | 0.68 | 0.98 |
| Example 6c | 66.1% | 8.43 × 10⁻⁴ | 0.65 | 220 | 150 | 0.68 | 0.97 |
| Example 7 | 66.5% | 8.49 × 10⁻⁴ | 0.65 | 220 | 150 | 0.68 | 0.98 |
| Example 8a | 66.3% | / | 0.65 | 220 | 150 | 0.68 | 0.97 |
| Example 8b | 66.5% | / | 0.65 | 220 | 150 | 0.68 | 0.98 |
| Example 8c | 66.4% | / | 0.65 | 220 | 150 | 0.68 | 0.97 |
| Example 9a | 66.5% | / | 0.65 | 220 | 150 | 0.68 | 0.98 |
| Example 9b | 66.4% | / | 0.65 | 220 | 150 | 0.68 | 0.97 |
| Example 10 | 66.6% | 8.5 × 10⁻⁴ | 0.65 | 220 | 150 | 0.68 | 0.98 |
| Example 11a | 66.4% | 8.47 × 10⁻⁴ | 0.65 | 220 | 150 | 0.68 | 0.97 |
| Example 11b | 66.3% | 8.46 × 10⁻⁴ | 0.65 | 220 | 150 | 0.68 | 0.97 |
| Example 12 | 66.5% | 8.49 × 10⁻⁴ | 0.65 | 220 | 150 | 0.68 | 0.98 |
| Example 13 | 66.5% | 8.49 × 10⁻⁴ | 0.65 | 220 | 150 | 0.68 | 0.98 |
| Example 14 | 66.2% | 8.45 × 10⁻⁴ | 0.65 | 220 | 150 | 0.68 | 0.97 |
| Example 15a | 66.3% | 8.46 × 10⁻⁴ | 0.65 | 220 | 150 | 0.68 | 0.97 |
| Example 15b | 66.2% | 8.45 × 10⁻⁴ | 0.65 | 220 | 150 | 0.68 | 0.97 |
| Example 16a | 66.5% | 8.49 × 10⁻⁴ | 0.65 | 220 | 150 | 0.68 | 0.98 |
| Example 16b | 66.1% | 8.43 × 10⁻⁴ | 0.65 | 220 | 150 | 0.68 | 0.97 |
| Example 16c | 66.3% | 8.46 × 10⁻⁴ | 0.65 | 220 | 150 | 0.68 | 0.97 |
| Example 17 | 66.5% | 8.49 × 10⁻⁴ | 0.65 | 220 | 150 | 0.68 | 0.98 |
| Example 18 | 66.6% | 8.5 × 10⁻⁴ | 0.58 | 220 | 80 | 0.36 | 1.83 |

“/” in Table 1 indicated no data.

### Test Example II

### (1) Volumetric Energy Density Test

The batteries prepared in the examples and comparative examples were subjected to a volumetric energy density test, and the specific test method was as follows:

the battery was charged to 4.5 V at a current of 0.2 C, then charged at a constant voltage until the current dropped to 0.02 C, and then discharged to 3.0 V at a current of 0.2 C, and the discharge energy was recorded as E; and the thickness, width, and length of the battery were measured, the product of the three was calculated, and the volume of the battery was recorded as V. The formula for calculating the volumetric energy density was VED=E/V, and the results were reported in Table 2.

### (2) Low-Temperature Discharge Test

At room temperature (25° C.), the battery was charged to 4.5 V at 0.2 C in a constant-current and constant-voltage manner, and the charging process was stopped at 0.02 C; after standing for 5 min, the battery was discharged to 3.0 V at 0.2 C, and the discharge capacity C1 was recorded; the battery was then charged to 4.5 V at 0.2 C in a constant-current and constant-voltage manner at room temperature, and the charging process was stopped at 0.02 C; thus, the battery was fully charged; the fully charged battery was placed in a thermostatic chamber at −20° C., left to stand for 2 hours, and then discharged to 3.0 V at 0.2 C, and the discharge capacity C2 was recorded; and C2/C1 was namely the low-temperature discharge capacity retention rate at 0.2 C at −20° C., and the results were recorded in Table 2.

### (3) High-Temperature Cycling Test at 45° C.

The batteries prepared in the examples and comparative examples were subjected to a high-temperature cycling test at 45° C., and the specific test method was as follows:
the battery was left to stand in a constant-temperature room at 45° C. for 2 h, charged to 4.25V at 3.3 C in a constant-current manner, then charged to 4.5 V at 2.7 C in a constant-current and constant-voltage manner, the charging process was stopped at 0.05 C, and the battery was left to stand for 10 min; and the battery was then discharged to 3.0 V at 0.7 C, and this process was repeated in this way for 600 cycles. The discharge capacity of the battery was measured to be C1 when it was fully charged at the 600th cycle. The discharge capacity of the battery was CO when it was fully charged for the first time. Thus, C1/C0 was namely the capacity retention rate after 600 cycles, and the results were recorded in Table 1. After the cycling was completed, the battery was disassembled, and whether the positive electrode current collector was broken was observed. The results were recorded in Table 2.

TABLE 2

| | Energy | Low-temperature | Cycling | Was |
|---|---|---|---|---|
| | density | discharge capacity | capacity | there |
| | (Wh/L) | retention rate | retention rate | breakage? |
| Example 1 | 760 | 88.5% | 87.5% | No |
| Example 2 | 761 | 88.5% | 87.9% | No |
| Example 3 | 760 | 88.1% | 87.1% | No |
| Example 4a | 745 | 90.5% | 88.9% | No |
| Example 4b | 780 | 78.4% | 80.3% | No |
| Example 4c | 715 | 91.3% | 89.9% | No |
| Example 4d | 790 | 77.4% | 79.6% | No |
| Example 5a | 763 | 88.9% | 85.5% | No |
| Example 5b | 758 | 87.5% | 87.7% | No |
| Example 6a | 756 | 88.2% | 87.9% | No |
| Example 6b | 765 | 88.7% | 84.9% | No |
| Example 6c | 767 | 88.9% | 84.5% | No |
| Example 7 | 754 | 88.9% | 86.2% | No |
| Example 8a | 762 | 89.5% | 87.3% | No |
| Example 8b | 762 | 89.2% | 87.5% | No |
| Example 8c | 762 | 89.9% | 87.1% | No |
| Example 9a | 762 | 88.3% | 87.4% | No |
| Example 9b | 761 | 88.1% | 87.1% | No |
| Example 10 | 761 | 88.9% | 88.4% | No |
| Example 11a | 762 | 88.4% | 86.5% | No |
| Example 11b | 757 | 88.5% | 88.3% | No |
| Example 12 | 759 | 88.1% | 86.9% | No |
| Example 13 | 760 | 87.9% | 85.5% | No |
| Example 14 | 758 | 88.7% | 86.7% | No |
| Example 15a | 760 | 88.6% | 86.9% | No |
| Example 15b | 761 | 88.2% | 86.5% | No |
| Example 16a | 760 | 86.8% | 87.9% | No |
| Example 16b | 759 | 86.3% | 87.7% | No |
| Example 16c | 760 | 86.0% | 88.4% | No |
| Example 17 | 760 | 89.3% | 85.6% | No |
| Example 18 | 760 | 88.5% | 85.5% | Yes |
| Comparative | 710 | 91.9% | 90.3% | No |
| Example 1 | | | | |
| Comparative | 810 | 75.4% | 76.6% | No |
| Example 2 | | | | |

As can be seen from Table 2, compared with the comparative examples, the batteries of the present disclosure can achieve a balance between a higher energy density and a better low-temperature discharge performance.

The preferred embodiments of the present disclosure have been described in detail above; however, the present disclosure is not limited thereto. Within the technical concept of the present disclosure, various simple modifications can be made to the technical solution of the present disclosure, including the combination of various technical features in any other suitable way. These simple modifications and combinations should also be regarded as the content disclosed by the present disclosure and all fall within the scope of protection of the present disclosure.

1. A lithium-ion secondary battery, comprising a jelly roll obtained by winding a positive electrode plate, a separator and a negative electrode plate; wherein
the negative electrode plate comprises a negative electrode current collector and a negative electrode active coating layer located on at least one surface of the negative electrode current collector, the negative electrode active coating layer comprises a silicon-carbon material, and a mass content of element Si in the negative electrode active coating layer c1 ranges from 1.5% to 8.5%;
the positive electrode plate comprises a positive electrode active material, and the positive electrode active material comprises lithium cobaltate; and
an inflection point of a Zero Current Voltage curve of the lithium-ion secondary battery corresponds to a value Z on an X axis, and Z ranges from 55% to 90%;
the jelly roll comprises an arcuate region and a flat straight region connected to the arcuate region; and a ratio of a radius R of the arcuate region to half a thickness T/2 of the jelly roll is r, and r and Z satisfy: 0.54≤r×Z≤0.825; and
the positive electrode plate comprises a positive electrode current collector and a positive electrode active coating layer located on at least one surface of the positive electrode current collector; a length of the positive electrode active coating layer located on a first surface of the positive electrode current collector is greater than a length of the positive electrode active coating layer located on a second surface of the positive electrode current collector; a region where a projection of the positive electrode active coating layer located on the first surface overlaps with a projection of the positive electrode active coating layer located on the second surface in a thickness direction of the positive electrode plate is a double-sided coating region, and a region where the projections do not overlap is a single-sided coating region; a surface of the positive electrode active coating layer located on the first surface comprises second recesses, and a surface of the positive electrode active coating layer located on the second surface comprises protrusions; the positive electrode plate comprises the double-sided coating region and the single-sided coating region, and the second recesses and the protrusions are located in the double-sided coating region and not in the single-sided coating region; and the protruding direction of the protrusions is away from the center of the jelly roll.

2. The lithium-ion secondary battery according to claim 1, wherein c1 ranges from 3.5% to 6.5%; and/or
Z ranges from 60% to 75%.

3. The lithium-ion secondary battery according to claim 1, wherein the positive electrode active coating layer comprises the positive electrode active material, and the lithium cobaltate comprises element Al; and a charged cut-off voltage of the lithium-ion secondary battery is greater than or equal to 4.5 V.

4. The lithium-ion secondary battery according to claim 3, wherein a mass content of the element Al in the positive electrode active coating layer ranges from 6800 ppm to 15000 ppm.

5. The lithium-ion secondary battery according to claim 4, wherein the mass content of the element Al in the positive electrode active coating layer ranges from 7000 ppm to 10000 ppm.

6. The lithium-ion secondary battery according to claim 1, wherein the silicon-carbon material comprises a primary spherical particle, and an average particle size of the primary spherical particle ranges from 1 μm to 6 μm.

7. The lithium-ion secondary battery according to claim 6, wherein the average particle size of the primary spherical particle ranges from 3 μm to 5 μm; and/or
the silicon-carbon material further comprises a secondary spherical particle formed from a plurality of the primary spherical particles; and/or
a mass content of the element Si in the silicon-carbon material ranges from 30% to 80%; and/or
the negative electrode active coating layer further comprises a graphite material.

8. The lithium-ion secondary battery according to claim 7, wherein a proportion of a number of the primary spherical particles in the negative electrode active coating layer relative to a total number of the primary spherical particles and the secondary spherical particles ranges from 0.1 to 0.9; and/or
the graphite material comprises a secondary particle, and an average particle size of the secondary particle ranges from 6 μm to 20 μm.

9. The lithium-ion secondary battery according to claim 1, wherein the lithium-ion secondary battery further comprises an electrolyte solution, and the electrolyte solution comprises vinylene carbonate and propylene carbonate; and/or
the negative electrode active coating layer further comprises a first solid electrolyte, and the first solid electrolyte comprises at least one of lithium aluminum titanium phosphorus oxide, lithium lanthanum zirconium tantalum oxide, or lithium lanthanum titanium oxide.

10. The lithium-ion secondary battery according to claim 9, wherein a sum of mass contents of vinylene carbonate and propylene carbonate in the electrolyte solution ranges from 10% to 40%; and/or
the first solid electrolyte comprises element M¹, and the element M¹ comprises at least one of Ti, Zr, La, or Ta; and a mass content of the element M¹ in the negative electrode active coating layer c2 and the mass content of the element Si in the negative electrode active coating layer c1 satisfy: 0.01≤c2/c1≤0.5.

11. The lithium-ion secondary battery according to claim 10, wherein the sum of the mass contents of vinylene carbonate and propylene carbonate in the electrolyte solution ranges from 10% to 25%; and/or
0.05≤c2/c1≤0.1; and/or
an average particle size of the first solid electrolyte ranges from 500 nm to 3 μm.

12. The lithium-ion secondary battery according to claim 1, wherein the positive electrode active coating layer comprises a second solid electrolyte, and the second solid electrolyte comprises at least one of lithium aluminum titanium phosphorus oxide, lithium lanthanum zirconium tantalum oxide, or lithium lanthanum titanium oxide.

13. The lithium-ion secondary battery according to claim 12, wherein the second solid electrolyte comprises element M², and the element M² comprises at least one of Ti, Zr, La, or Ta; and a mass content of the element M² in the positive electrode active coating layer c3 and the value Z of the inflection point corresponding to the X axis satisfy: 3.3×10⁻⁴≤c3×Z≤1.4×10⁻³.

14. (canceled)

15. The lithium-ion secondary battery according to claim 1,
wherein 0.59≤r×Z≤0.73; and/or
r ranges from 0.9 to 1.1.

16. The lithium-ion secondary battery according to claim 1, wherein the jelly roll comprises an arcuate region and a flat straight region connected to the arcuate region; the arcuate region comprises a plurality of layers of arcs, an arc near a winding center is an inner arc, and an arc away from the winding center is an outer arc;
the jelly roll comprises the positive electrode plate; the positive electrode plate comprises the double-sided coating region and the single-sided coating region;
a tensile strength of the positive electrode plate in a width direction is S1; in the arc with the double-sided coating region, the tensile strength of the positive electrode plate at the outermost arc and in the double-sided coating region along a length direction is S2; and a compressive strength of the positive electrode plate S is S2/S1, and S and Z satisfy: 0.6≤Z/S≤2.

17. The lithium-ion secondary battery according to claim 1, wherein an outer surface of the negative electrode active coating layer comprises first recesses;
a depth of the first recesses ranges from 5 μm to 40 μm; and/or
a width of the first recesses ranges from 40 μm to 200 μm; and/or
a spacing between the first recesses ranges from 0.8 mm to 1.5 mm.

18. (canceled)

19. The lithium-ion secondary battery according to claim 1, wherein the positive electrode plate comprises a positive electrode tab welding region, a pasting region, and an empty foil region, and the second recesses and the protrusions are located in the pasting region; and/or
a depth of the second recesses ranges from 3 μm to 40 μm, a width of the second recesses ranges from 0.2 mm to 8 mm, and a spacing between the second recesses ranges from 0.5 mm to 8 mm; and/or
a height of the protrusions ranges from 3 μm to 40 μm, a width of the protrusions ranges from 0.2 mm to 8 mm, and a spacing between the protrusions ranges from 0.5 mm to 8 mm.

20. The lithium-ion secondary battery according to claim 1, wherein the positive electrode plate comprises a positive electrode tab welding region, a pasting region, and an empty foil region, and the pasting region comprises the double-sided coating region and the single-sided coating region;
a distance from the second recesses to an edge of the positive electrode tab welding region is w1, with 0 mm<w1≤10 mm; and/or
a distance from the second recesses to an edge of a first side of the pasting region is w2, with 2 mm≤w2≤40 mm, and the first side is a side where the positive electrode tab welding region is arranged; and/or
a distance from the second recesses to an edge of a second side of the pasting region is w3, with 2 mm<w3≤25 mm, and the second side is a side opposite to the side where the positive electrode tab welding region is arranged; and/or
a distance from the second recesses to an edge of a third side of the pasting region is w4, with 0 mm<w4≤20 mm, and the third side is a side of the pasting region close to a winding head end; and/or
a distance from the second recesses to a boundary line between the double-sided coating region and the single-sided coating region is w5, with 0 mm<w5≤20 mm.

21. The lithium-ion secondary battery according to claim 1, wherein the first surface faces the winding center of the jelly roll, and the second surface faces away from the winding center of the jelly roll.
